(19) United States
(12) Patent Application Publication
(10) Pub. No.: US 2008/0010543 A1
(43) Pub. Date: Jan. 10, 2008

(54) Test planning assistance apparatus, test planning assistance method, and recording medium having test planning assistance program recorded therein

(75) Inventors: Hiroshi Yamamoto, Kyoto (JP); Kiyotaka Kasubuchi, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD

(21) Appl. No.: 11/808,956

(22) Filed: Jun. 14, 2007

(30) Foreign Application Priority Data
Jun. 15, 2006 (JP) P2006-165606
May 8, 2007 (JP) P2007-123870

(51) Int. Cl. G06F 11/00

(52) U.S. Cl. 714/38

(57) ABSTRACT

A test specification table has a plurality of test cases stored therein. A test case table has stored therein test execution information per test case in each test project. A test performance table has stored therein the number of actual man-days for testing per test specification in each test project. In a progress estimation process, the number of man-days estimated to be required for subsequent test execution in the current test project is calculated based on past test execution information and the number of actual man-days in the past. Furthermore, an estimated time period is calculated based on the number of estimated man-days and the number of involved workers. Thereafter, estimated test progress is displayed in the form of a graph in a graph area of a scheduled performance display dialog.

### BACKGROUND OF THE INVENTION

1. Field of the Invention

The present invention relates to a test planning assistance apparatus and a test planning assistance method that assist in generating a test plan when testing is repeatedly executed during software system development or suchlike.

2. Description of the Background Art

Conventionally, there have been various known software system development methodologies, including the “waterfall development methodology”, the “prototype development methodology” and the “spiral development methodology”. Software system development phases of these various development methodologies include “requirements definition”, “designing”, “programming”, “testing” and so on. Among these phases, “testing” of a software system is generally carried out in accordance with a test specification. The test specification describes for each test case a test method, conditions for determining a pass or fail (a success or failure), and so on. Examples of the testing include a “unit test” for performing an operation test mainly on a module-by-module basis, a “join test” for mainly testing consistency between modules, and a “system test” for testing, for example, if there is any operational problem with a whole system.

In software system development, the aforementioned phases are generally repeated. Accordingly, a plurality of test phases are provided during a period from the start to end of development of one product. Therefore, test cases created in early stages of the development or test cases additionally created in accordance with changes to the specification are repeatedly tested.

There are problems with such testing for software system development and suchlike, regarding how efficiently a test plan (schedule) is created or how the difference between the original plan and actual performance can be minimized. Japanese Laid-Open Patent Publication No. 2003-256206 discloses an invention related to a method and program for assisting in test planning for a software system.

In each test phase, the project administrator initially generates a test plan. However, it is often the case that, after testing is actually started, the testing does not progress as originally planned. In such a case, the project administrator adjusts the test plan, considering the status of the test progress. However, in some cases, the testing might not progress as planned even after such adjustments. Such a case will be described with reference to FIGS. 43 to 46.

In FIGS. 43 to 46, test schedules (plans) and actual performance (progress) are shown in graph form in which the horizontal axis denotes a period of time and the vertical axis denotes the number of test cases. For example, actual test performance at time point t is assumed as shown in FIG. 43. In such a case, the project administrator estimates that the subsequent testing progresses as shown in FIG. 44, considering the status of the progress up to the time point t. In reality, however, as shown in FIG. 45, the testing might not progress as estimated, or as shown in FIG. 46, the testing might progress more than estimated. The reason for this is that the time required for test execution varies from one test case to another because the difficulty and complexity of the testing varies among the test cases.

For example, in the case where a test specification containing a number of test cases that require a relatively long period of time for execution are tested during a period from the commencement day of the testing to the time point t, it is conceivable that the test progress is faster at and after the time point t, compared to any preceding time points. On the other hand, in the case where a test specification containing a number of test cases that require a relatively short period of time for execution are tested during the period from the commencement day of the testing to the time point t, it is conceivable that the test progress is slower at and after the time point t, compared to any preceding time points.

In this manner, even if the test progress can be estimated, the actual test progress varies depending on the difficulty and complexity of the testing. Accordingly, the project administrator encounters difficulties in generating a test plan and distributing resources such as manpower and devices. In addition, the project administrator is required to administer the project, considering risks such as operational delays in the entire system development due to delays in the test progress.

Also, when the same worker repeatedly executes tests, in general, the more tests he/she experiences, the shorter the time required for test execution becomes. However, skills of such workers are not taken into consideration when the test plan is generated.

### SUMMARY OF THE INVENTION

Therefore, an objective of the present invention is to provide a test planning assistance apparatus and a test planning assistance method that allow a test plan to be generated such that the difference between the schedule and the actual performance is minimized. Also, another objective of the present invention is to reflect skills of workers in the test plan, thereby increasing the accuracy of the test plan.

The present invention has the following features to attain the objectives mentioned above.

One aspect of the present invention is directed to a test planning assistance apparatus for assisting in generating a test plan for a test project externally designated from among a plurality of repeated test projects, the apparatus including:

a test case holding section for holding a plurality of test cases including test cases that are to be executed in the designated test project;

a test result holding section for holding, for each test project, a test result including test execution information that indicates whether each test case has been tested;

an actual man-day number holding section for holding an actual man-day number for each test case group including one or more test cases, wherein the actual man-day number indicates the number of man-days spent for test execution in each test project; and

an estimated man-day number calculating section for calculating an estimated man-day number that indicates the number of man-days estimated to be required for test execution in the designated test project,

wherein the estimated man-day number calculating section calculates the estimated man-day number based on the test execution information held in the test result holding section, regarding the test cases that are to be executed in the designated test project, and the actual man-day number held in the actual man-day number holding section, regarding a test case group including the test cases that are to be executed in the designated test project.

According to this configuration, for each test case group consisting of test cases contained in each test case holding section, the number of man-days (actual man-day number) spent for test execution in each test project is held in the actual man-day number holding section. In addition, the test result holding section holds, for each test project, the test execution information that indicates whether each test case has been tested. Furthermore, the estimated man-day number calculating section calculates the number of man-days estimated to be required for executing the testing that is to be performed in the designated test project, based on the actual man-day number held in the actual man-day number holding section, and the test execution information held in the test result holding section. Accordingly, the number of estimated man-days is calculated, considering the difficulty and complexity of test cases. Thus, it is possible to minimize the difference between the number of estimated man-days and the number of actual man-days.

Preferably, the apparatus thus configured further includes:

an involved worker number input section for externally inputting an involved worker number that indicates the number of workers who execute testing during a term of the designated test project; and

an estimated time period calculating section for calculating a time period estimated to be required for test execution in the designated test project, based on the estimated man-day number calculated by the estimated man-day number calculating section and the involved worker number inputted by the involved worker number input section.

According to this configuration, the time period estimated to be required for test execution is calculated based on the estimated man-day number calculated by the estimated man-day number calculating section and the involved worker number inputted by the involved worker number input section. Thus, the estimated time period can be calculated based on past test performance, so that the difference between the estimated time period and an actual time period is minimized.

In the apparatus thus configured, the estimated man-day number calculating section preferably includes:

a first arithmetic section for calculating a group-specific actual man-day average number for each test case group, based on the test execution information held in the test result holding section and the actual man-day number held in the actual man-day number holding section, wherein the group-specific actual man-day average number indicates the number of actual man-days per test case; and

a second arithmetic section for calculating the estimated man-day number based on the group-specific actual man-day average number calculated by the first arithmetic section and the number of test cases that are to be executed per test case group in the designated test project.

According to this configuration, the estimated man-day number is calculated after the actual man-day number per test case is calculated for each test case group, based on past test execution information and the number of actual man-days in the past. Thus, the estimated man-day number is calculated, considering the difficulty and complexity of testing for each test case group.

Preferably, the apparatus thus configured further includes:

a skill information holding section for holding skill information that indicates each worker's testing skill for each test case group; and

a skill information updating section for updating the skill information in the skill information holding section when the same worker has executed consecutive rounds of testing for the same test case group, wherein when the number of consecutive rounds is P, which is a natural number of two or higher, the skill information regarding the P'th round of testing is updated based on the number of actual man-days spent for executing the first one of the P consecutive rounds of testing and the number of actual man-days spent for executing the P'th round of testing,

wherein the estimated man-day number calculating section includes a skill-considered man-day number calculating section for calculating a requisite man-day number when the same worker is executing consecutive rounds of testing for the same test case group, wherein when the number of consecutive rounds is Q, which is a natural number of two or higher, the requisite man-day number indicates the number of man-days required for executing the Q'th round of testing, and is calculated based on the skill information held in the skill information holding section, regarding the Q'th round of testing.

According to this configuration, the skill information holding section holds information indicating each worker's testing skill in executing consecutive rounds of testing for the same test case group. Furthermore, the skill-considered man-day number calculating section calculates the number of actual man-days required for test execution, based on the skill information held in the skill information holding section. Thus, the estimated man-day numbers are calculated, considering the individual workers' testing skill.

Preferably, the apparatus thus configured further includes a test case selecting section for selecting the test cases that are to be executed in the designated test project, based on the test results held in the test result holding section.

According to this configuration, the test cases that are to be executed in the designated test project are selected based on past test results. Thus, the number of man-days estimated to be required for test execution is calculated after the test cases are selected such that the testing is efficiently executed.

Another aspect of the present invention is directed to a computer-readable recording medium having recorded therein a test planning assistance program for use with a test planning assistance apparatus for assisting in generating a test plan for a test project externally designated from among a plurality of repeated test projects, the program causing the apparatus to execute:

a test case holding step for holding, in a predetermined test case holding section, a plurality of test cases including test cases that are to be executed in the designated test project;

a test result holding step for holding a test result for each test project in a predetermined test result holding section, wherein the test result includes test execution information that indicates whether each test case has been tested;

an actual man-day number holding step for holding, in a predetermined actual man-day number holding section, an actual man-day number for each test case group including one or more test cases, wherein the actual man-day number indicates the number of man-days spent for test execution in each test project; and

an estimated man-day number calculating step for calculating an estimated man-day number that indicates the number of man-days estimated to be required for test execution in the designated test project,

wherein in the estimated man-day number calculating step, the estimated man-day number is calculated based on the test execution information held in the test result holding section, regarding the test cases that are to be executed in the designated test project, and the actual man-day number held in the actual man-day number holding section, regarding a test case group including the test cases that are to be executed in the designated test project.

In the computer-readable recording medium, preferably, the test planning assistance program thus configured further causing the test planning assistance apparatus to execute:

an involved worker number input step for externally inputting an involved worker number that indicates the number of workers who execute testing during a term of the designated test project; and

an estimated time period calculating step for calculating a time period estimated to be required for test execution in the designated test project, based on the estimated man-day number calculated in the estimated man-day number calculating step and the involved worker number inputted in the involved worker number input step.

In the computer-readable recording medium, preferably, the test planning assistance program thus configured, the estimated man-day number calculating step includes:

a first arithmetic step for calculating a group-specific actual man-day average number for each test case group, based on the test execution information held in the test result holding section and the actual man-day number held in the actual man-day number holding section, wherein the group-specific actual man-day average number indicates the number of actual man-days per test case; and

a second arithmetic step for calculating the estimated man-day number based on the group-specific actual man-day average number calculated in the first arithmetic step and the number of test cases that are to be executed per test case group in the designated test project.

In the computer-readable recording medium, preferably, the test planning assistance program thus configured further causing the test planning assistance apparatus to execute:

a skill information holding step for holding, in a predetermined skill information holding section, skill information that indicates each worker's testing skill for each test case group; and

a skill information updating step for updating the skill information in the skill information holding section when the same worker has executed consecutive rounds of testing for the same test case group, wherein when the number of consecutive rounds is P, which is a natural number of two or higher, the skill information regarding the P'th round of testing is updated based on the number of actual man-days spent for executing the first one of the P consecutive rounds of testing and the number of actual man-days spent for executing the P'th round of testing,

wherein the estimated man-day number calculating step includes a skill-considered man-day number calculating step for calculating a requisite man-day number when the same worker is executing consecutive rounds of testing for the same test case group, wherein when the number of consecutive rounds is Q, which is a natural number of two or higher, the requisite man-day number indicates the number of man-days required for executing the Q'th round of testing, and is calculated based on the skill information held in the skill information holding section, regarding the Q'th round of testing.

In the computer-readable recording medium, preferably, the test planning assistance program thus configured further causing the test planning assistance apparatus to execute:

a test case selecting step for selecting the test cases that are to be executed in the designated test project, based on the test results held in the test result holding section.

Still Another aspect of the present invention is directed to a test planning assistance method for assisting in generating a test plan for a test project externally designated from among a plurality of repeated test projects, the method comprising:

a test case holding step for holding, in a predetermined test case holding section, a plurality of test cases including test cases that are to be executed in the designated test project;

a test result holding step for holding a test result for each test project in a predetermined test result holding section, wherein the test result includes test execution information that indicates whether each test case has been tested;

an actual man-day number holding step for holding, in a predetermined actual man-day number holding section, an actual man-day number for each test case group including one or more test cases, wherein the actual man-day number indicates the number of man-days spent for test execution in each test project; and

an estimated man-day number calculating step for calculating an estimated man-day number that indicates the number of man-days estimated to be required for test execution in the designated test project,

wherein in the estimated man-day number calculating step, the estimated man-day number is calculated based on the test execution information held in the test result holding section, regarding the test cases that are to be executed in the designated test project, and the actual man-day number held in the actual man-day number holding section, regarding a test case group including the test cases that are to be executed in the designated test project.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating the configuration of a test planning assistance apparatus according to a first embodiment of the present invention.

FIG. 2 is a hardware configuration diagram of an overall system in the first embodiment.

FIG. 3 is a diagram for explaining testing in software system development in the first embodiment.

FIG. 4 is a conceptual diagram for explaining test projects in the first embodiment.

FIG. 5 is a diagram illustrating a record format of a test specification table in the first embodiment.

FIG. 6 is a diagram illustrating a record format of a test case table in the first embodiment.

FIG. 7 is a diagram illustrating a record format of a test performance table in the first embodiment.

FIG. 8 is a diagram illustrating a scheduled performance display dialog in the first embodiment.

FIG. 9 is a diagram for explaining an optimization process in the first embodiment.

FIG. 10 is a flowchart illustrating a typical operational procedure for testing in each test project in the first embodiment.

FIG. 11 is a diagram illustrating an exemplary circle graph displayed by a test result aggregate display process in the first embodiment.

FIG. 12 is a diagram illustrating an exemplary table displayed by the test result aggregate display process in the first embodiment.

FIG. 13 is a flowchart illustrating the procedure for a test case management process in the first embodiment.

FIG. 14 is a diagram illustrating a screen displayed for the test case management process in the first embodiment.

FIG. 15 is a flowchart illustrating the procedure for a test schedule generation process in the first embodiment.

FIG. 16 is a diagram illustrating a screen for inputting the term of each test project in the first embodiment.

FIG. 17 is a diagram illustrating an exemplary graph displayed by the test schedule generation process in the first embodiment.

FIG. 18 is a flowchart illustrating the procedure for a test result management process in the first embodiment.

FIG. 19 is a diagram illustrating a screen displayed for the test result management process in the first embodiment.

FIG. 20 is a flowchart illustrating the procedure for a test performance display process in the first embodiment.

FIG. 21 is a diagram illustrating an exemplary graph displayed by the test performance display process in the first embodiment.

FIG. 22 is a flowchart illustrating the procedure for a progress estimation process in the first embodiment.

FIG. 23 is a diagram illustrating a screen for inputting an involved worker number for each test project in the first embodiment.

FIG. 24 is a diagram illustrating an exemplary graph displayed by the progress estimation process in the first embodiment.

FIG. 25 is a flowchart illustrating the procedure for an estimated man-day number calculation process in the first embodiment.

FIG. 26 is a diagram for explaining the estimated man-day number calculation process in the first embodiment.

FIG. 27 is a diagram illustrating a screen for inputting a group-specific actual man-day number in the first embodiment.

FIG. 28 is a diagram for explaining effects of the first embodiment.

FIG. 29 is a diagram illustrating an exemplary graph displayed by the progress estimation process after the optimization process in the first embodiment.

FIG. 30 is a diagram illustrating record formats after normalization of the test specification table in the first embodiment.

FIG. 31 is a block diagram illustrating the configuration of a test planning assistance apparatus according to a second embodiment of the present embodiment.

FIG. 32 is a diagram for explaining execution information in the second embodiment.

FIG. 33 is a diagram illustrating exemplary information held as the execution information in the second embodiment.

FIG. 34 is a diagram schematically illustrating exemplary data stored in a skill information table in the second embodiment.

FIG. 35 is a diagram for explaining the skill information table in the second embodiment.

FIG. 36 is another diagram for explaining the skill information table in the second embodiment.

FIG. 37 is a diagram illustrating a record format of the skill information table in the second embodiment.

FIG. 38 is a flowchart illustrating the procedure for a skill information table updating process in the second embodiment.

FIG. 39 is a diagram for explaining the skill information table updating process in the second embodiment.

FIG. 40 is a flowchart illustrating the procedure for performing a skill-considered estimated man-day number calculation process in the second embodiment.

FIG. 41 is a diagram for explaining the skill-considered estimated man-day number calculation process in the second embodiment.

FIG. 42 is another diagram for explaining the skill-considered estimated man-day number calculation process in the second embodiment.

FIG. 43 is a diagram for explaining how a conventional software system testing plan is generated.

FIG. 44 is another diagram for explaining how the conventional software system test plan is generated.

FIG. 45 is still another diagram for explaining how the conventional software system test plan is generated.

FIG. 46 is still another diagram for explaining how the conventional software system test plan is generated.

### DESCRIPTION OF THE PREFERRED EMBODIMENTS

Hereinafter, embodiments of the present invention will be described with reference to the accompanying drawings.

### 1. First Embodiment

<1.1 Overall Configuration>

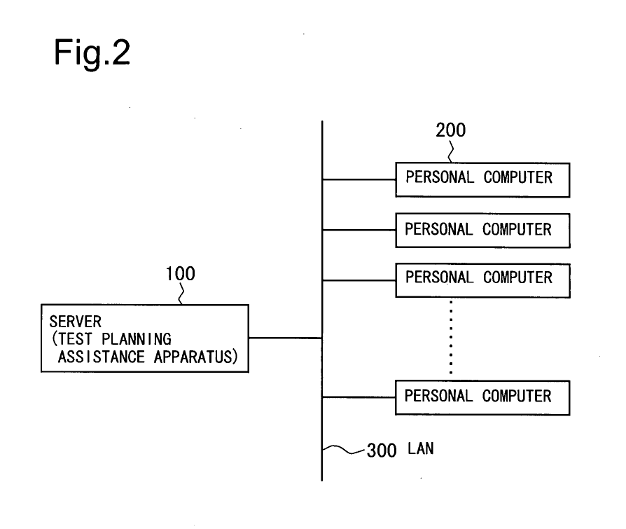

FIG. 2 is a hardware configuration diagram of an overall system including a test planning assistance apparatus according to a first embodiment of the present invention. The system includes a server 100 and a plurality of personal computers 200. The server 100 and the personal computers 200 are connected to each other via a LAN 300. The server 100 executes processing in accordance with a request from each personal computer 200, and stores files, databases, etc., that can be commonly referenced from each personal computer 200. In addition, the server 100 functions to, for example, generate a test plan for software system development or suchlike and estimate the progress of testing. Therefore, the server is referred to below as the “test planning assistance apparatus”. The personal computers 200 perform tasks such as programming for software system development, execution of testing, and so on.

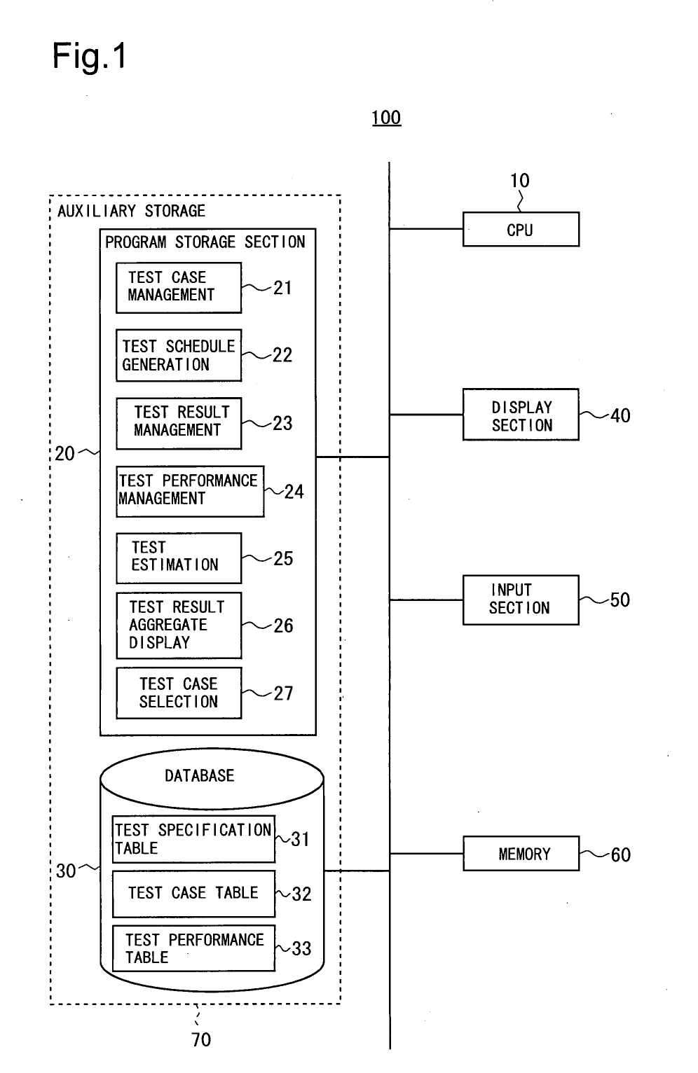

FIG. 1 is a block diagram illustrating the configuration of the test planning assistance apparatus 100. The test planning assistance apparatus 100 includes a CPU 10, a display section 40, an input section 50, a memory 60 and an auxiliary storage 70. The auxiliary storage 70 includes a program storage section 20 and a database 30. The CPU 10 performs arithmetic processing in accordance with a given instruction. The program storage section 20 has stored therein seven programs (execution modules) 21 to 27, which are respectively labeled “TEST CASE MANAGEMENT”, “TEST SCHEDULE GENERATION”, “TEST RESULT MANAGEMENT”, “TEST PERFORMANCE MANAGEMENT”, “TEST ESTIMATION”, “TEST RESULT AGGREGATE DISPLAY”, AND “TEST CASE SELECTION”. The database 30 has stored therein three tables 31 to 33, which are respectively labeled “TEST SPECIFICATION”, “TEST CASE”, and “TEST PERFORMANCE”. For example, the display section 40 displays an operation screen, which is used by an operator, for example, in order to input test cases through the test case management program 21, or a screen showing the status of test progress (schedule, actual performance, and estimation). The input section 50 receives an input from the operator via a mouse or a keyboard. The memory 60 temporarily stores data required for arithmetic processing by the CPU 10.

Note that in the present embodiment, the test planning assistance apparatus 100 has been described as being solely composed of the server, but for example, it may be composed of the personal computer 200 including the display section 40 and the input section 50. For example, this allows the operator to use the personal computer 200 to execute a process for inputting test cases and test results, and a process for displaying the status of the test progress.

<1.2 Test Project>

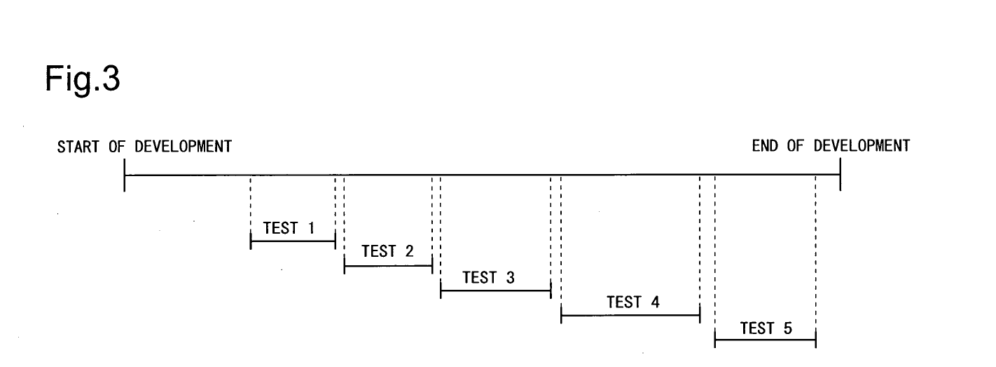

Next, the concept of the “test project” according to the present embodiment will be described. In software system development, the testing is performed a plurality of times during a period from the start to end of development of one system (product). In some cases, for example, five rounds of testing are performed during the period from the start to end of the development as shown in FIG. 3. In general, the entire testing from the start to end of the development is often regarded as a task unit and referred to as the “test project”, but in the present embodiment, each round of the testing (as a task unit) is referred to as the “test project”. Accordingly, in the example shown in FIG. 3, five test projects are present in the period from the start to end of the development.

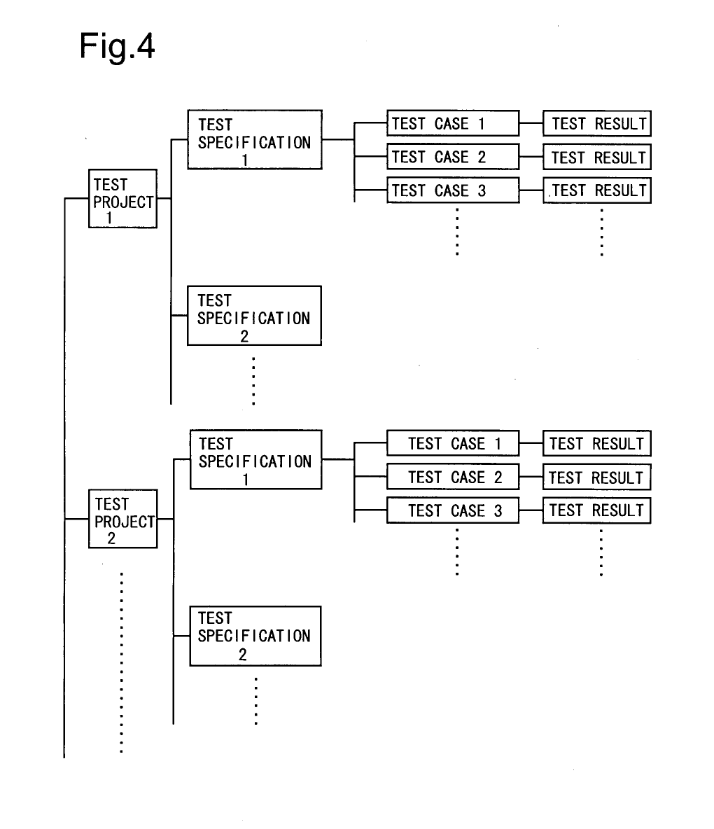

Each test project is correlated with a plurality of test specifications as shown in FIG. 4. That is, in each test project, the testing is performed based on the test specifications. For example, eighty test specifications may be used for testing in a single test project.

In addition, each test specification is correlated with a plurality of test cases as shown in FIG. 4. That is, each test specification contains the plurality of test cases. For example, a single test specification may contain fifty test cases. Also, each test case is correlated with a test result (e.g., data indicating whether the testing is successful or not).

In the software system development, the testing is repeatedly performed as described above, and therefore each test specification is repeatedly used. Specifically, the first round of the testing is performed based on test specifications generated in early stages of the development, and thereafter the same test specifications are used for performing the second and subsequent rounds of the testing. However, the test specifications or test cases are added or deleted in accordance with, for example, addition or deletion of functions during the development.

<1.3 Tables>

Described next are tables held in the database 30 in the present embodiment.

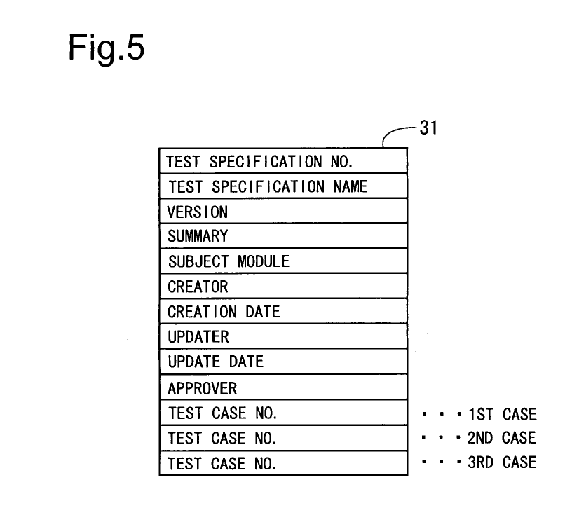

FIG. 5 is a diagram illustrating a record format of the test specification table 31. The test specification table 31 contains a plurality of items, which are respectively labeled “TEST SPECIFICATION NO.”, “TEST SPECIFICATION NAME”, “VERSION”, “SUMMARY”, “SUBJECT MODULE”, “CREATOR”, “CREATION DATE”, “UPDATER”, “UPDATE DATE”, “APPROVER” and “TEST CASE NO.”. Note that “TEST CASE NO.” is repeated by the number of test cases included in the test specification. Also, in the present embodiment, a test case group is constituted by test cases included in each test specification.

In item fields of the test specification table 31 (regions where data items are stored), data items as described below are stored. Stored in the “TEST SPECIFICATION NO.” field is a number for identifying the test specification, and the number is uniquely assigned in each test project. Stored in the “TEST SPECIFICATION NAME” field is a name by which a developer, a tester, etc., can identify the test specification. Stored in the “VERSION” field is a version of the test specification. Stored in the “SUMMARY” field is a description summarizing the test specification. Stored in the “CREATOR” field is the name of the test specification creator. Stored in the “CREATION DATE” field is the creation date of the test specification. Stored in the “UPDATER” field is the name of the person who last updated the test specification. Stored in the “UPDATE DATE” field is the update date of the test specification. Stored in the “APPROVER” field is the name of the person who approved the details of the test specification. Stored in the “TEST CASE NO.” field is a number for identifying a test case, and the number is uniquely assigned within a test project.

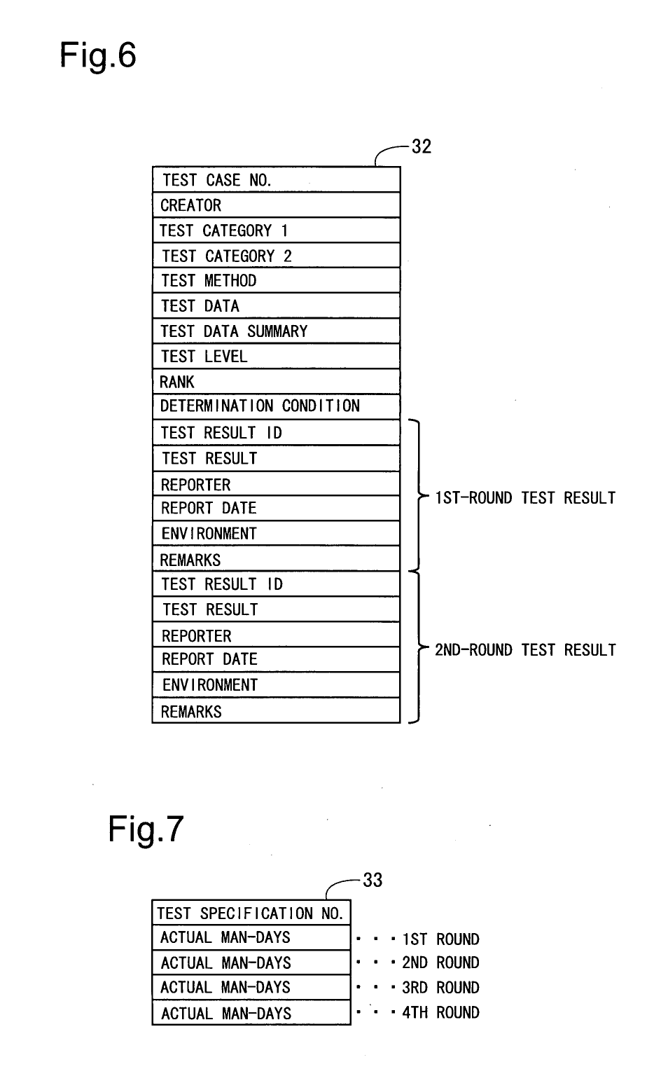

FIG. 6 is a diagram illustrating a record format of the test case table 32. The test case table 32 contains a plurality of items, which are respectively labeled “TEST CASE NO.”, “CREATOR”, “TEST CATEGORY 1”, “TEST CATEGORY 2”, “TEST METHOD”, “TEST DATA”, “TEST DATA SUMMARY”, “TEST LEVEL”, “RANK”, “DETERMINATION CONDITION”, “TEST RESULT ID”, “TEST RESULT”, “REPORTER”, “REPORT DATE”, “ENVIRONMENT” and “REMARKS”. Note that “TEST RESULT ID”, “TEST RESULT”, “REPORTER”, “REPORT DATE”, “ENVIRONMENT” and “REMARKS” are repeated by the number of rounds of testing performed on the test case. Noted that in the present embodiment, a test case holding section is implemented by the test case table 32. Furthermore, a test result holding section is implemented by the “TEST RESULT” field in the test case table 32.

In item fields of the test case table 32, data items as described below are stored. Stored in the “TEST CASE NO.” field is a number for identifying the test case, and the number is uniquely assigned within a test project. Note that the “TEST CASE NO.” field in the test specification table 31 and the “TEST CASE NO.” field in the test case table 32 are linked with each other. Stored in the “CREATOR” field is the name of the test case creator. Stored in the “TEST CATEGORY 1” field is the name of a category into which the test case is categorized in accordance with a predetermined rule. The category name may be “normal system”, “abnormal system” or “load”, for example. Stored in the “TEST CATEGORY 2” field is the name of a category into which the test case is categorized in accordance with a rule different from that for the “TEST CATEGORY 1” field. The category name may be “function” or “boundary value”, for example. Stored in the “TEST METHOD” field is a description explaining a method for executing the testing. Stored in the “TEST DATA” field is a description for specifying data for executing the testing (e.g., a full pathname). Stored in the “TEST DATA SUMMARY” field is a description summarizing the test data. Stored in the “TEST LEVEL” field is the level of the test case. The level may be “unit test”, “join test” or “system test”, for example. Stored in the “RANK” field is the importance level of the test case. The importance level may be “H”, “M” or “L”, for example. Stored in the “DETERMINATION CONDITION” field is a description explaining the criterion for determining a pass or fail in the testing. Stored in the “TEST RESULT ID” field is a number for identifying a result of testing the test case. Stored in the “TEST RESULT” field is the result of the testing. In the present embodiment, the test result may be “success”, “failure”, “untested” or “unexecuted”. Stored in the “REPORTER” field is the name of the person who reported the test result. Stored in the “REPORT DATE” field is the report date of the test result. Stored in the “ENVIRONMENT” field is a description explaining a system environment or the like at the time of the testing. Stored in the “REMARKS” field is a description such as a comment on the testing.

As for the test result, “success” is meant to indicate that the test result is successful (pass) , “failure” is meant to indicate that the test result is unsuccessful (fail), “untested” is meant to indicate that the testing is not performed on the test case, and “unexecuted” is meant to indicate that the test case has not yet been tested in the current test phase. In the present embodiment, the details of the test result are used as “test execution information”. Specifically, if the test result is “success” or “failure”, it is understood that the testing has been executed, while if the test result is “untested” or “unexecuted”, it is understood that the testing has not been executed.

FIG. 7 is a diagram illustrating a record format of the test performance table 33. The test performance table 33 contains a plurality of items, which are respectively labeled “TEST SPECIFICATION NO.” and “ACTUAL MAN-DAYS”. The item “ACTUAL MAN-DAYS” is repeated by the number of test projects (the number of rounds of the testing). Note that in the present embodiment, an actual man-day holding section is implemented by the test performance table 33.

In item fields of the test performance table 33, data items as described below are stored. Stored in the “TEST SPECIFICATION NO.” field is a number for identifying a test specification, and the number is uniquely assigned in each test project. Stored in the “ACTUAL MAN-DAYS” field is the number of man-days spent for test execution in an associated test project. Note that the “TEST SPECIFICATION NO.” in the test specification table 31 and the “TEST SPECIFICATION NO.” in the test performance table 33 are linked with each other.

<1.4 Scheduled Performance Display Dialog>

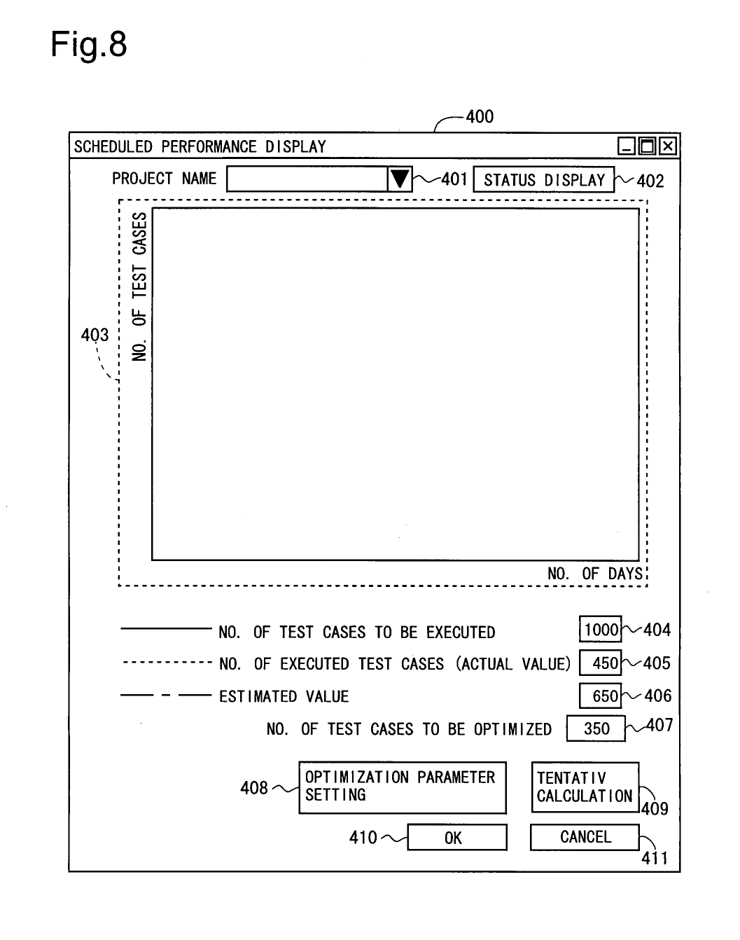

Described next is a screen (hereinafter, referred to as the “scheduled performance display dialog”) 400 for displaying scheduled test progress, actual test progress, and estimated test progress in the present embodiment. FIG. 8 is a diagram illustrating the scheduled performance display dialog 400. The scheduled performance display dialog 400 includes: a list box 401 for selecting a test project name; a status display button 402 for giving an instruction to display the status of test progress (schedule, actual performance, and estimation) ; a graph area 403 for displaying the status of test progress in the form of a graph; a display area 404 for displaying the number of test cases that are to be executed in a test project (designated test project) designated in the list box 401; a display area 405 for displaying the number of test cases that have been executed in the designated test project; a display area 406 for displaying the number of test cases that are estimated to be executed by a scheduled completion date (a cumulative total from the commencement day to the scheduled completion day) ; a display area 407 for displaying the number of test cases that are “untested” in the designated test project in accordance with an optimization process to be described later; an optimization parameter setting button 408 for giving an instruction to execute parameter setting for the optimization process; a tentative calculation button 409 for giving an instruction to recalculate the number of estimated man-days based on the optimization process; an OK button 410 for changing a test result(s) in the test case table 32 (e.g., changing “unexecuted” to “untested”) based on the result obtained by the tentative calculation; and a cancellation button 411 for canceling and terminating the processing.

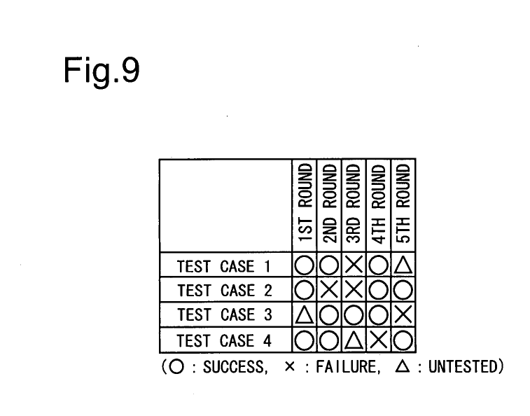

The optimization process will now be described. The optimization process refers to a process for selecting preferred test cases in order to efficiently perform the testing, considering past test results. The optimization process is executed, for example, when it is estimated that the testing of all test cases will not be completed by a previously scheduled completion day. The test planning assistance apparatus 100 is capable of acquiring the test result for each test case in each test project from the test case table 32. For example, in the case where the test results are acquired as shown in FIG. 9, any test cases that have been “failed” in recent rounds of the testing can be preferentially selected as test targets. In the present embodiment, when the tentative calculation button 409 in the scheduled performance dialog 400 is pressed, the test case selection program 27, which acts as a test case selecting section, is executed to perform the optimization process.

<1.5 Testing>

<1.5.1 Overall Flow>

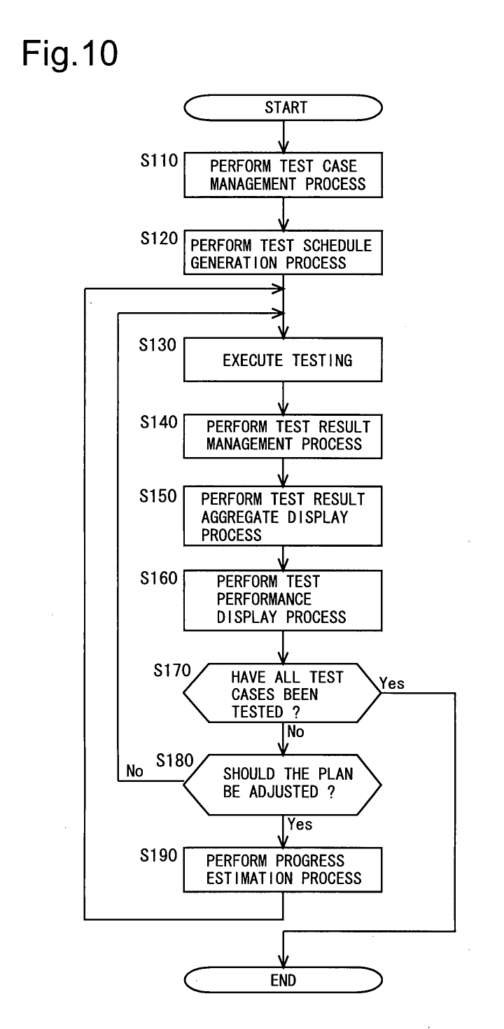

Described next is a testing procedure using the test planning assistance apparatus 100 according to the present embodiment. FIG. 10 is a flowchart illustrating a typical operational procedure for testing in each test project. Note that FIG. 10 is not showing the order of operations by the test planning assistance apparatus 100 itself, but the test planning assistance apparatus 100 achieves efficiency when the testing is operated in accordance with the procedure shown in FIG. 10. Also, the test project that is currently being executed or about to be started is hereinafter referred to as the “current test project”. The “current test project” is designated by the operator (e.g., the project administrator) using the list box 401 in the scheduled performance dialog 400.

After the current test project is started, the test case management program 21 is executed in the test planning assistance apparatus 100 to perform a test case management process (step S110). The test case management process is meant to indicate registration of a new test case(s) to the database 30, deletion of an existing test case(s) from the database 30, and correction of the details of the existing test case(s) in the database 30.

When all test cases that are to be executed in the current test project are stored to the database 30 in accordance with the test case management process, the procedure advances to step S120. In step S120, the test schedule generation program 22 is executed in the test planning assistance apparatus 100 to perform a test schedule generation process. In the test schedule generation process, a test progress schedule for the current test project is generated, and a graph indicating the schedule is displayed in the graph area 403 of the scheduled performance display dialog 400.

After step S120 is completed, the procedure advances to step S130, where the testing is executed (step S130). The execution of the testing is performed by the worker called the “tester” based on test specifications. After the testing is completed, the procedure advances to step S140.

Instep S140, the test result management program 23is executed in the test planning assistance apparatus 100 to perform a test result management process. The test result management process is meant to indicate inputting of a test result(s) to the database 30, and editing (correction) of the test result(s) in the database 30.

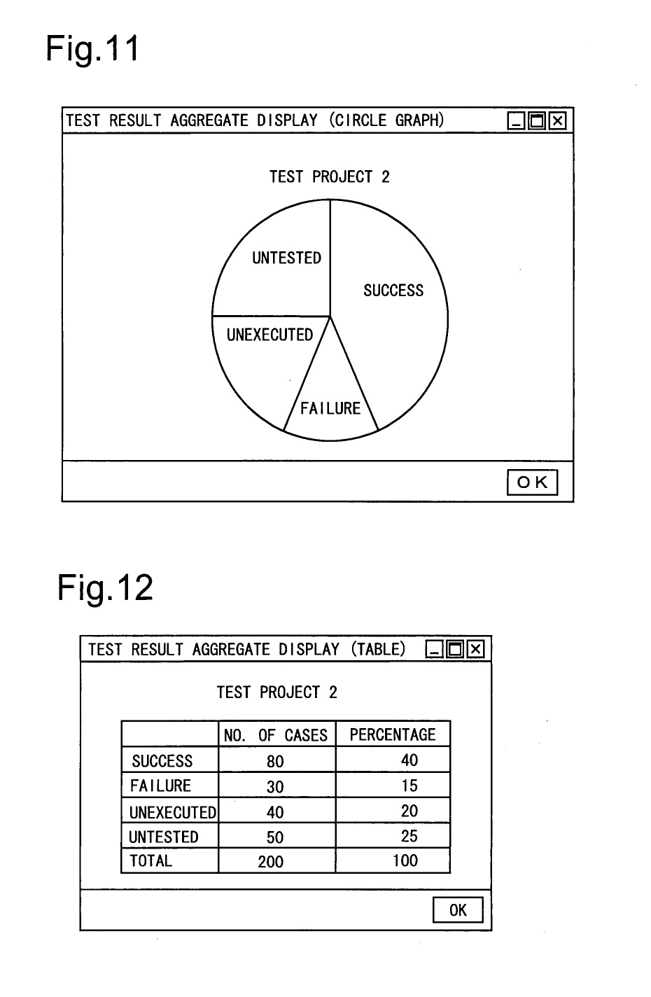

After step S140 is completed, the procedure advances to step S150. In step S150, the test result aggregate display program 26 is executed in the test planning assistance apparatus 100 to perform a test result aggregated is play process. In the test result aggregate display process, an aggregate of the results of executed testing is displayed in the form of a graph, a table, or the like. For example, the aggregate is displayed in the form of a circle graph as shown in FIG. 11 or in the form of a table as shown in FIG. 12. Note that in the present embodiment, a test result aggregate display section is implemented by step S150.

After step S150 is completed, the procedure advances to step S160. In step S160, the test performance management program 24 is executed in the test planning assistance apparatus 100 to perform a test performance display process. In the test performance display process, a graph indicating actual test progress in the current test project is displayed in the graph area 403 of the scheduled performance display dialog 400.

After step S160 is completed, the procedure advances to step S170, where it is determined whether all the test cases that are to be executed in the current test project have already been tested. If the result is that all the test cases have already been tested, the testing for the current test project is completed. On the other hand, if all the test cases have not yet been tested, the procedure advances to step S180.

In step S180, the project administrator determines whether to adjust the test plan for the current test project. If the project administrator determines not to adjust the test plan, the procedure returns to step S130. On the other hand, if the project administrator determines to adjust the test plan, the procedure advances to step S190.

In step S190, the test estimation program 25 is executed in the test planning assistance apparatus 100 to perform a progress estimation process. In the progress estimation process, a time period (estimated period) required for subsequent test execution in the current test project is calculated, and a graph indicating estimated test progress is displayed in the graph area 403 of the scheduled performance display dialog 400. Also, in the progress estimation process, the test case selection program 27 is executed in the test planning assistance apparatus 100, so that the project administrator can select test cases, considering past test results.

<1.5.2 Test Case Management Process>

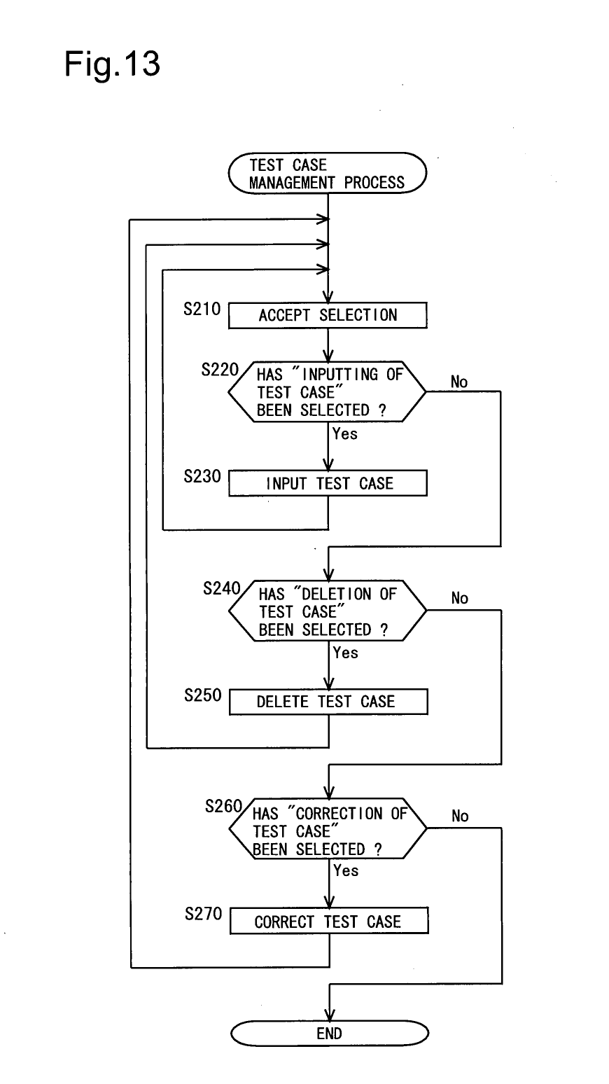

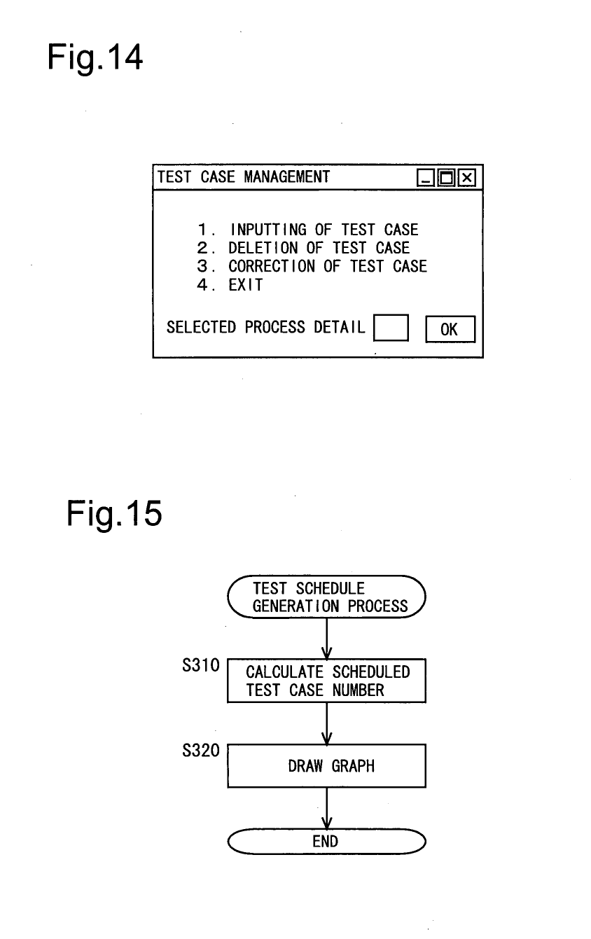

FIG. 13 is a flowchart illustrating the procedure for the test case management process. When the test case management process is started, the test planning assistance apparatus 100 displays a screen (dialog) as shown in FIG. 14 in order to cause the operator to select a process detail, and accepts an input (selection of the process detail) from the operator (step S210). After step S210, the procedure advances to step S220, where it is determined whether “INPUTTING OF TEST CASE” has been selected (as the process detail). If the determination result is that “INPUTTING OF TEST CASE” has been selected, the procedure advances to step S230. On the other hand, if “INPUTTING OF TEST CASE” has not been selected, the procedure advances to step S240.

In step S230, inputting of a test case(s) by the operator is accepted. The test planning assistance apparatus 100 adds the details of the test case(s) inputted by the operator to the database 30 as a new piece of data. After step S230 is completed, the procedure returns to step S210.

In step S240, it is determined whether “DELETION OF TEST CASE” has been selected (as the process detail). If the determination result is that “DELETION OF TEST CASE” has been selected, the procedure advances to step S250. On the other hand, if “DELETION OF TEST CASE” has not been selected, the procedure advances to step S260.

In step S250, selection of a deletion target test case(s) by the operator is accepted. The test planning assistance apparatus 100 deletes the test case(s) selected by the operator from the database 30. After step S250 is completed, the procedure returns to step S210.

In step S260, it is determined whether “CORRECTION OF TEST CASE” has been selected (as the process detail). If the determination result is that “CORRECTION OF TEST CASE” has been selected, the procedure advances to step S270. On the other hand, if “CORRECTION OF TEST CASE” has not been selected, the test case management process is terminated.

In step S270, correction of a test case(s) by the operator is accepted. The test planning assistance apparatus 100 reflects the details of the test case correction by the operator in the database 30. After step S270 is completed, the procedure returns to step S210.

<1.5.3 Test Schedule Generation Process>

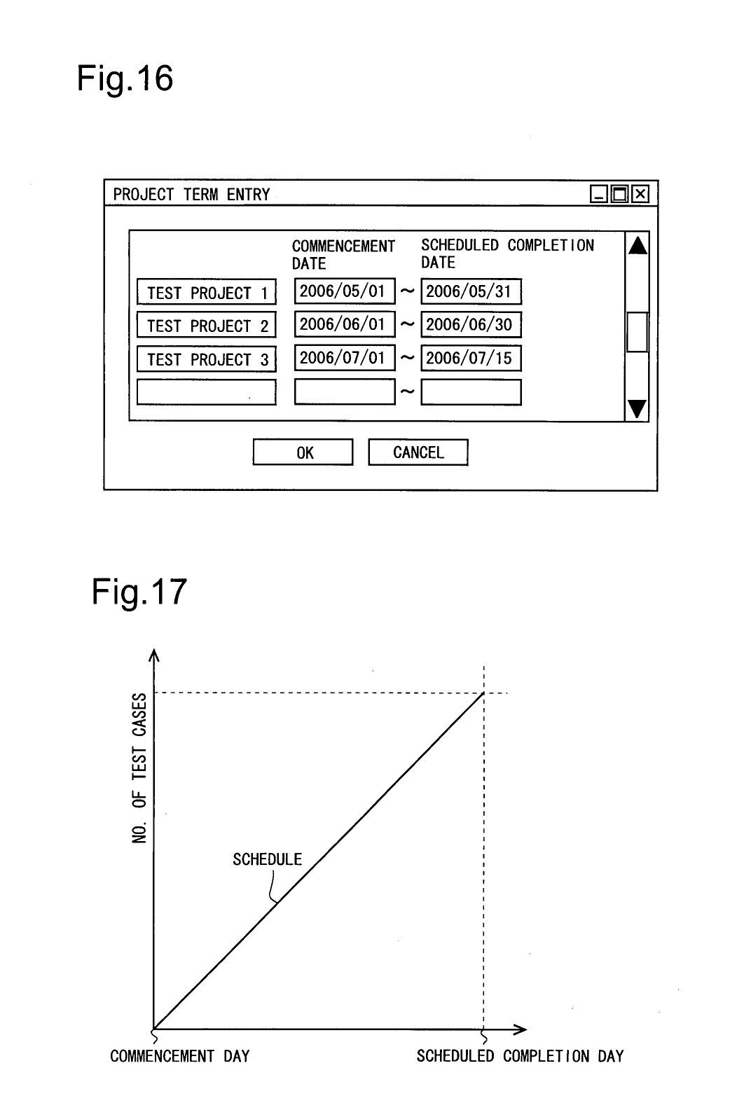

FIG. 15 is a flowchart illustrating the procedure for the test schedule generation process. When the test schedule generation process is started, the test planning assistance apparatus 100 calculates a scheduled test case number, i.e., the number of test cases that are to be executed per day, based on the number of test cases that are to be executed in the current test project and the term (number of days) of the test project (step S310). For example, the term (number of days) of the test project may be previously inputted by the operator (e.g., the project administrator) in accordance with a screen (dialog) as shown in FIG. 16. After step S310 is completed, the procedure advances to step S320.

In step S320, the test planning assistance apparatus 100 displays a test progress schedule in the graph area 403 of the scheduled performance display dialog 400 based on the scheduled test case number calculated in step S310. For example, the test progress schedule is displayed in the graph area 403 of the scheduled performance display dialog 400, in the form of a graph as shown in FIG. 17, in which the horizontal axis denotes a period of time and the vertical axis denotes the number of test cases. The test schedule generation process ends upon completion of step S320.

Note that in the present embodiment, a scheduled test case number calculating section is implemented by step S310, and a test progress schedule display section is implemented by step S320 and the scheduled performance display dialog 400.

<1.5.4 Test Result Management Process>

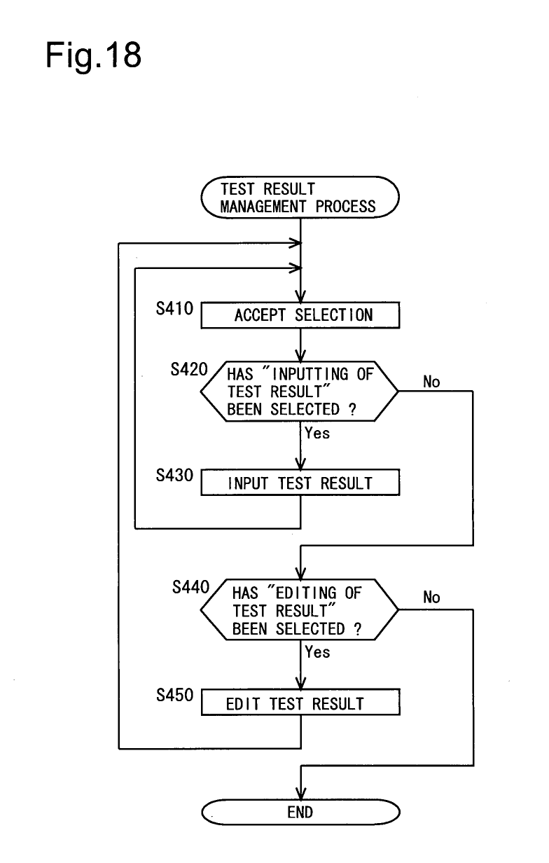

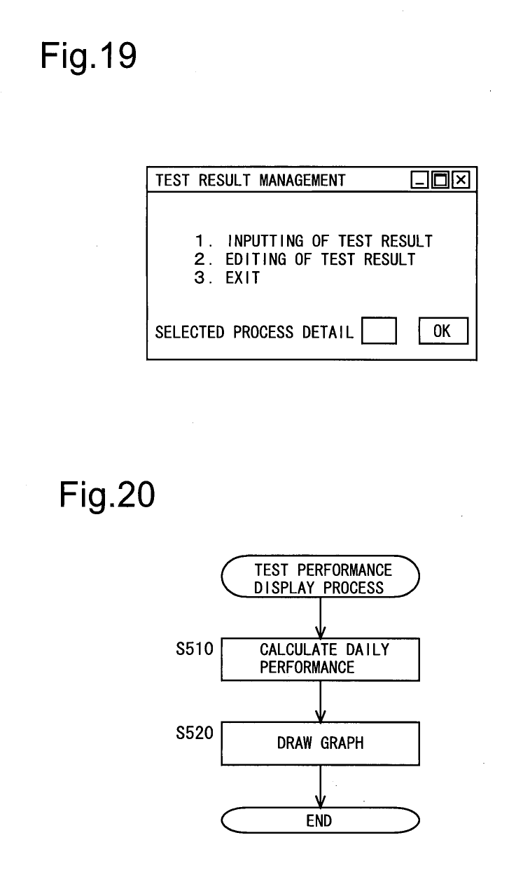

FIG. 18 is a flowchart illustrating the procedure for the test result management process. When the test result management process is started, the test planning assistance apparatus 100 displays a screen (dialog) as shown in FIG. 19 in order to cause the operator to select a process detail, and accepts an input (selection of the process detail) from the operator (step S410). After step S410, the procedure advances to step S420, where it is determined whether “INPUTTING OF TEST RESULT” has been selected (as the process detail). If the determination result is that “INPUTTING OF TEST RESULT” has been selected, the procedure advances to step S430. On the other hand, if “INPUTTING OF TEST RESULT” has not been selected, the procedure advances to step S440.

In step S430, inputting of a test result(s) by the operator is accepted. The test planning assistance apparatus 100 reflects the details of the test result(s) inputted by the operator in the database 30. After step S430 is completed, the procedure returns to step S410.

Instep S440, it is determined whether “EDITING OF TEST RESULT” has been selected (as the process detail). If the determination result is that “EDITING OF TEST RESULT” has been selected, the procedure advances to step S450. On the other hand, if “EDITING OF TEST RESULT” has not been selected, the test result management process is terminated.

In step S450, editing of the test result(s) by the operator is accepted. The test planning assistance apparatus 100 reflects the details of the test results edited by the operator in the database 30. After step S450 is completed, the procedure returns to step S410.

<1.5.5 Test Performance Display Process>

FIG. 20 is a flowchart illustrating the procedure for the test performance display process. When the test performance display process is started, the test planning assistance apparatus 100 obtains the number of rounds of testing executed per day during the current test project and a cumulative number thereof (an executed test case number) (step S510). After step S510 is completed, the procedure advances to step S520.

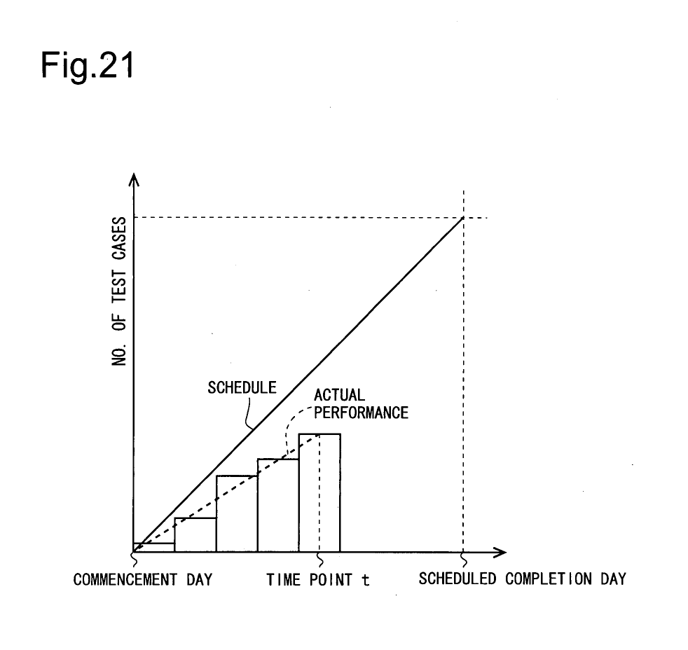

In step S520, the test planning assistance apparatus 100 displays actual test progress in the graph area 403 of the scheduled performance display dialog 400, based on the number of rounds of testing executed per day during the current test project and the cumulative number thereof, which are calculated in step S510. For example, the actual test progress is displayed in the form of a graph as shown in FIG. 21, in which the horizontal axis denotes a period of time and the vertical axis denotes the number of test cases. The test performance display process ends upon completion of step S520.

Note that in the present embodiment, an executed test case number acquiring section is implemented by step S510, and an actual test progress display section is implemented by step S520 and the scheduled performance display dialog 400.

<1.5.6 Progress Estimation Process>

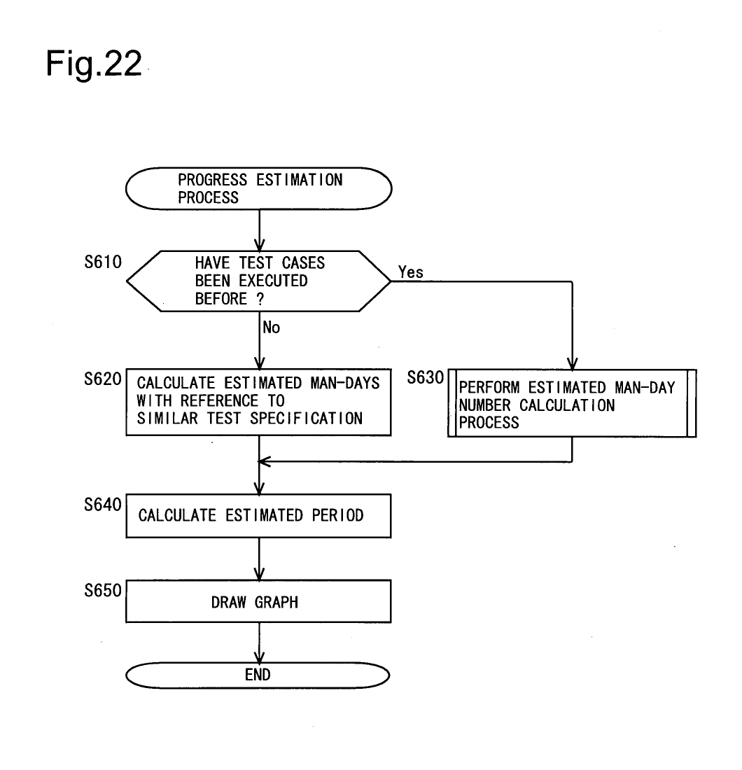

FIG. 22 is a flowchart illustrating the procedure for a progress estimation process. When the progress estimation process is started, the test planning assistance apparatus 100 determines whether test cases in the test specification that is to be (subsequently) executed in the current test project have already been executed in the past (step S610). If the determination result is that the test cases have already been executed in the past, the procedure advances to step S630. On the other hand, if the test cases have not yet been executed in the past, the procedure advances to step S620.

In step S620, the test planning assistance apparatus 100 causes the operator to select a test specification that is expected to require the same period of time (man-days) as the test specification that is to be executed, in accordance with a predetermined screen, and thereafter, the test planning assistance apparatus 100 calculates an estimated man-day number, i.e., the number of man-days estimated to be required for test execution, based on the number of past actual man-days spent for the selected test specification. After step S620 is completed, the procedure advances to step S640.

In step S630, the test planning assistance apparatus 100 performs an estimated man-day number calculation process based on the number of past actual man-days spent for the test specification that is to be executed. The estimated man-day number calculation process will be described in detail below. After step S630 is completed, the procedure advances to step S640.

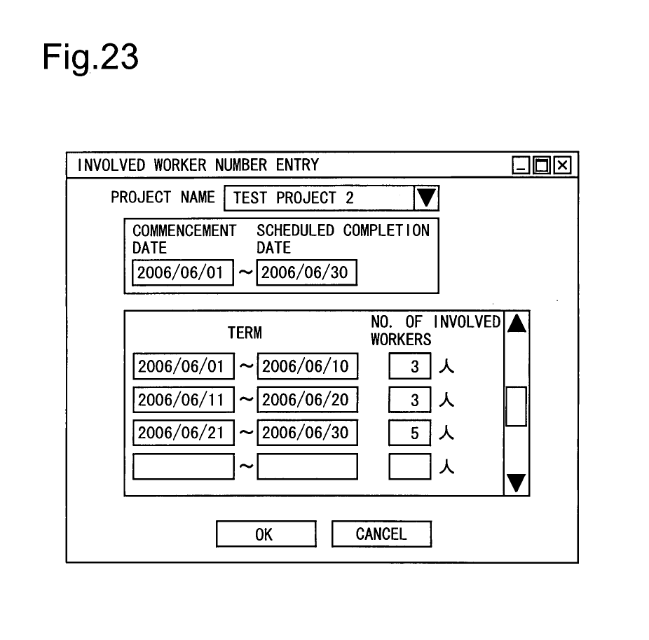

In step S640, the test planning assistance apparatus 100 calculates a time period estimated to be required for test execution by dividing the estimated man-day number calculated in step S620 or S630 by an involved worker number (i.e., the number of workers who execute the testing during the test period). For example, the involved worker number may be previously inputted by the operator (e.g., the project administrator) in accordance with a screen (dialog) as shown in FIG. 23. After step S640 is completed, the procedure advances to step S650.

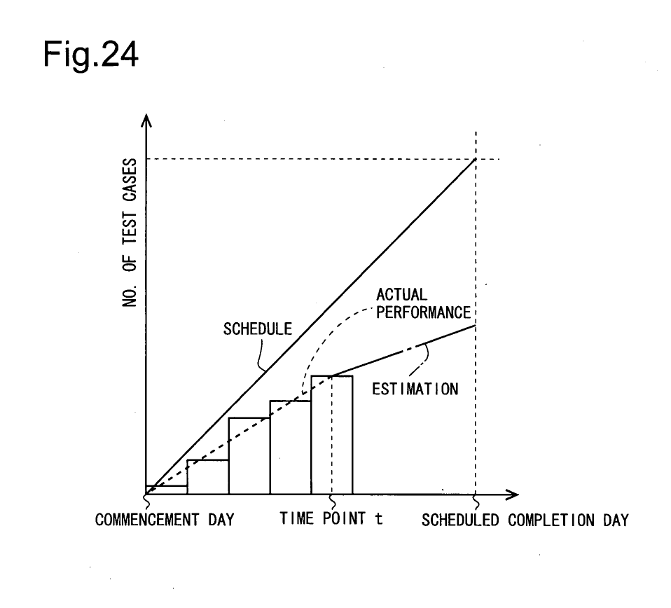

In step S650, the test planning assistance apparatus 100 displays estimated test progress in the graph area 403 of the scheduled performance display dialog 400 based on the estimated time period calculated in step S640. For example, the estimated test progress is displayed in the form of a graph as shown in FIG. 24, in which the horizontal axis denotes a period of time and the vertical axis denotes the number of test cases. The progress estimation process ends upon completion of step S650.

Note that in the present embodiment, an estimated man-day number calculating section is implemented by step S630, an estimated period calculating section is implemented by step S640, and an estimated test progress display section is implemented by step S650 and the scheduled performance display dialog 400.

<1.5.7 Estimated Man-Day Number Calculation Process>

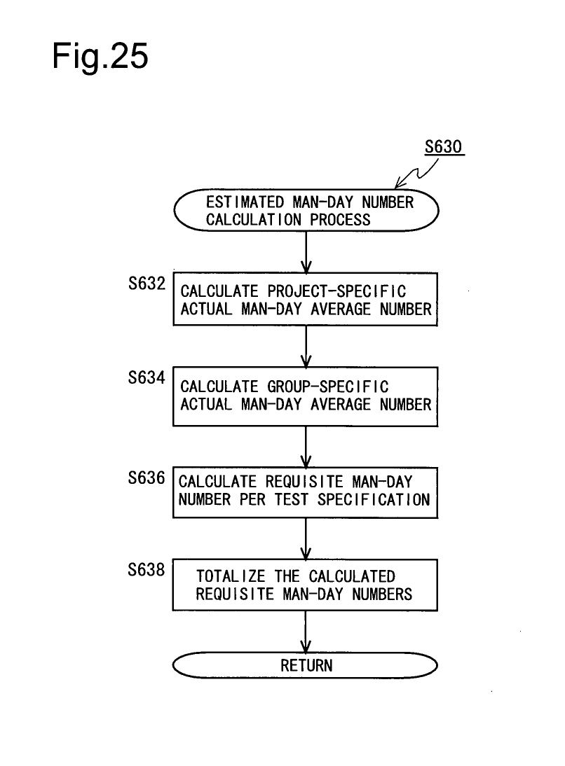

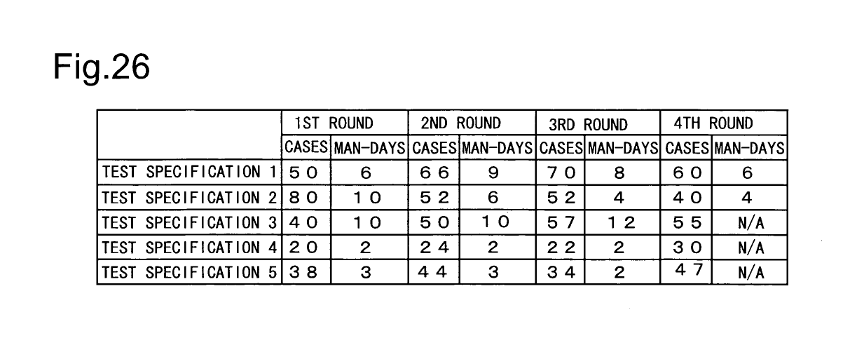

FIG. 25 is a flowchart illustrating the procedure for the estimated man-day number calculation process. The estimated man-day number calculation process will be described with respect to an example as shown in FIG. 26. In this example, it is assumed that five test specifications (test specifications 1 to 5) are used for testing, and the fourth round of the testing is currently being executed (i.e., the current test project is “TEST PROJECT 4”). In addition, it is assumed that in the current test project, the testing for the test specifications 1 and 2 has already been completed.

When the estimated man-day number calculation process is started, the test planning assistance apparatus 100 calculates the number of actual man-days per test case for each test specification on a project-by-project basis (hereinafter, referred to as the “project-specific actual man-day average number”) based on the details of test results held in the test case table 32 and actual man-day numbers held in the test performance table 33. The calculation is performed as described below.

The test case table 32 holds the test results for each test case on a project-by-project basis. Each test result is one of the following: “success”, “failure”, “untested”, and “unexecuted”. When the test result is “success” or “failure”, it is understood that the test case has been tested. On the other hand, when the test result is “untested” or “unexecuted”, it is understood that the test case has not been tested. In addition, the “TEST CASE NO.” in the test specification table 31 is linked with the “TEST CASE NO.” in the test case table 32. Therefore, for each test specification, it is possible to acquire the number of test cases that have been tested on a project-by-project basis as shown in FIG. 26.

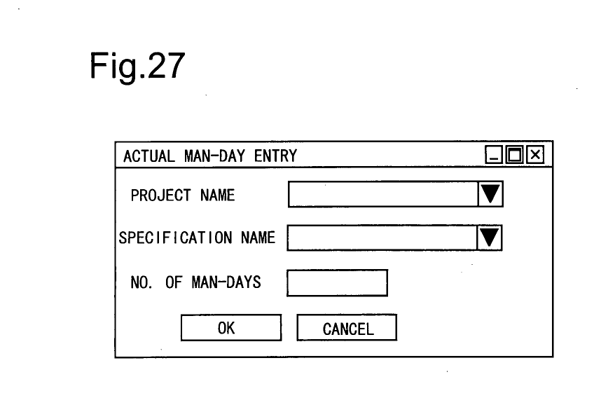

In addition, the test performance table 33 holds the actual man-day number for each test specification on a project-by-project basis. Accordingly, it is possible to acquire the actual man-day number for each test specification on a project-by-project basis as shown in FIG. 26. For example, the actual man-day number may be inputted for each test specification on a project-by-project basis by the operator (e.g., the project administrator) after completion of each test project, in accordance with a screen (dialog) as shown in FIG. 27.

As such, the number of test cases (that have been tested) and the actual man-day number are acquired for each test specification on a project-by-project basis, and therefore by dividing the actual man-day number by the number of test cases, it is possible to calculate the project-specific actual man-day average number. In the example shown in FIG. 26, the number of actual man-days per test case is calculated for each of the test specifications 3 to 5 on a project-by-project basis with respect to the first to third rounds of the testing.

After step S632 is completed, the procedure advances to step S634. In step S634, the test planning assistance apparatus 100 calculates the number of actual man-days per test case for each test specification (hereinafter, referred to as the “group-specific actual man-day average number”) based on the project-specific actual man-day average number calculated in step S632. Specifically, a sum total of the project-specific actual man-day average numbers is obtained for each test specification, and the sum total is divided by the number of test projects that have already been executed, thereby obtaining the group-specific actual man-day average number. In the example shown in FIG. 26, the sum total of the project-specific actual man-day average numbers for the first to third rounds of the testing is calculated for each of the test specifications 3 to 5, and the sum total is divided by “3” (i.e., the number of test projects that have already been executed). As a result, the group-specific actual man-day average number is calculated for each of the test specifications 3 to 5.

After step S634 is completed, the procedure advances to step S636. In step S636, the test planning assistance apparatus 100 calculates a requisite man-day number, i.e., the number of man-days required for test execution, for each test specification in the current test project based on the group-specific actual man-day average number calculated in step S632. Specifically, for each test specification, the number of test cases that are to be tested in the current test project is multiplied by the number of actual man-days per test case. In the example shown in FIG. 26, for each of the test specifications 3 to 5, the number of test cases that are to be executed in the fourth round of the testing is multiplied by the number of actual man-days per test case, thereby obtaining the requisite man-day number.

After step S636 is completed, the procedure advances to step S638. In step S638, the test planning assistance apparatus 100 calculates a sum total of the requisite man-day numbers calculated in step S636. As a result, the number of man-days estimated to be required for subsequent test execution in the current test project is calculated. In the example shown in FIG. 26, the requisite man-day numbers calculated for the test specifications 3 to 5 in step S636 are totalized. As a result, the number of man-days estimated to be required for subsequent test execution in the fourth test project is calculated. After step S638 is completed, the procedure advances to step S640 in FIG. 22.

Note that in the present embodiment, a project-specific actual man-day average number calculating section is implemented by step S632, a group-specific actual man-day average number calculating section is implemented by step S634, a group-specific requisite man-day number calculating section is implemented by step S636, and a group-specific requisite man-day number totalizing section is implemented by step S638. In addition, a first arithmetic section is implemented by steps S632 and S634, and a second arithmetic section is implemented by steps S636 and S638.

<1.6 Effects>

As described above, according to the present embodiment, each test specification contains a plurality of test cases, and for each test specification in each test project, the number of actual man-days spent for test execution (the actual man-day number) is held as data in the test performance table 33 within the database 30. In addition, the test case table 32 holds past test execution information (which indicates whether the testing has been executed) for each test case. When the test planning assistance apparatus 100 estimates the test progress, the number of man-days required for test execution (the requisite man-day number) for each test case that is to be subsequently executed in the current test project is calculated based on the actual man-day number stored in the test performance table 33 and the test execution information stored in the test case table 32. Thereafter, an overall estimated man-day number is calculated based on the requisite man-day number that is calculated for each test case in accordance with the past performance. Therefore, the requisite man-day number for subsequent test execution can be calculated, considering the difficulty and complexity of test cases that are to be subsequently executed. Thus, it is possible to reduce the difference between the estimated man-day number and the actual man-day number in the test project, compared to the difference conventionally incurred.

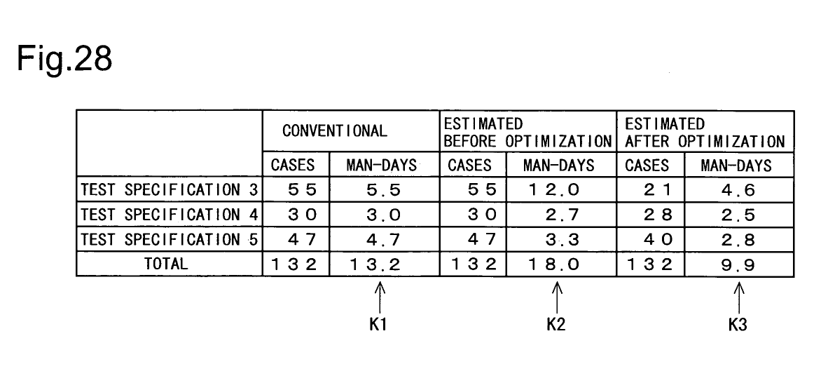

For example, in the case where the actual test performance is as shown in FIG. 26, the estimated man-day numbers for unexecuted test specifications (in FIG. 26, the test specifications 3 to 5) are conventionally calculated based on the actual man-day numbers for test specifications that have already been executed in the current test project (in FIG. 26, the test specifications 1 and 2). Accordingly, the estimated man-day numbers for the test specifications 3 to 5 are determined as indicated by reference character K1 in FIG. 28. On the other hand, according to the present embodiment, the estimated man-day numbers for the unexecuted test specifications are calculated based on the past actual man-day numbers of the unexecuted test specifications. Accordingly, the estimated man-day numbers for the test specifications 3 to 5 are determined as indicated by reference character K2 in FIG. 28. Therefore, there is a considerable difference between the number of man-days that is estimated in a conventional manner and the number of man-days that is estimated according to the present embodiment, but the number of man-days that is estimated according to the present embodiment differs less from the number of man-days that is actually required (because the number of man-days that is estimated according to the present embodiment is obtained based on the past actual man-day number).

As described above, the difference between the estimated man-day number and the actual man-day number can be reduced, and therefore, for example, it is possible for the project administrator to readily distribute resources, such as workers and devices, and manage test schedules.

In addition, in the present embodiment, a time period (estimated period) required for subsequent test execution is calculated based on the number of involved workers and the estimated man-day number, which is calculated in accordance with the past performance. Therefore, it is possible to reduce the difference between the estimated period and the actual period as compared to the difference conventionally incurred. Thus, it is possible to reduce the risk of delays in test progress.

Further, the scheduled progress, actual performance, and estimation are displayed per test project in the form of a graph in the scheduled performance display dialog 400. Therefore, it is possible for the project administrator to visually obtain the progress of the test project. Thus, it is possible for the project administrator to readily manage the progress of the test project.

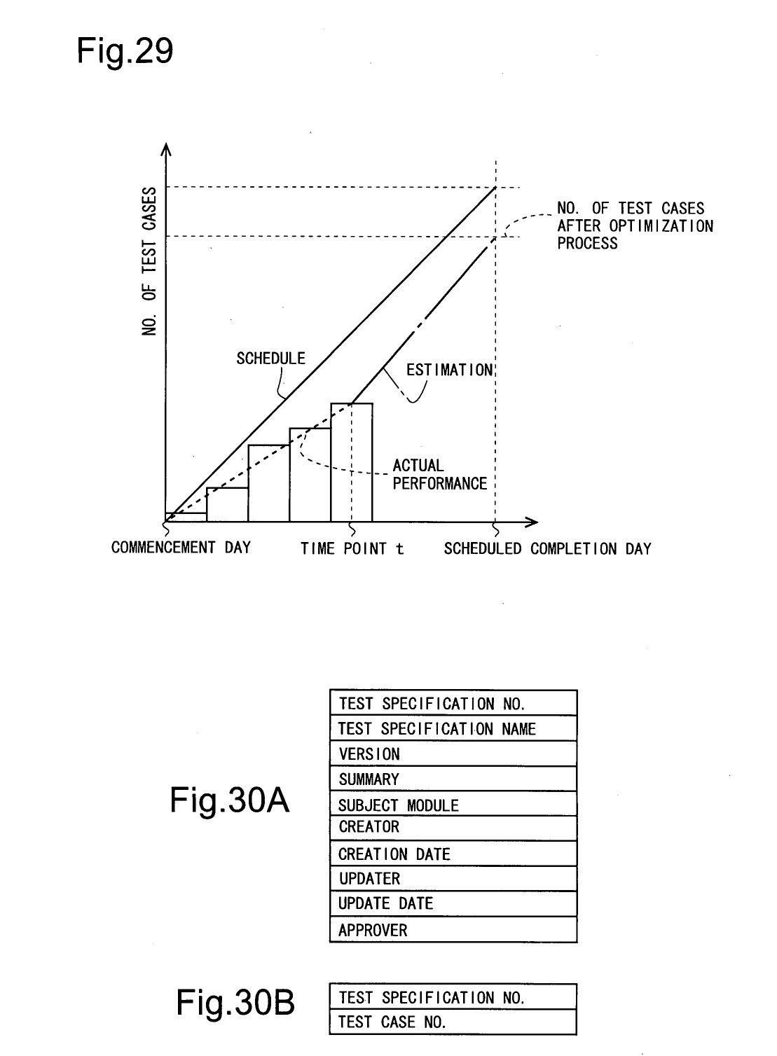

Furthermore, when estimating the test progress, it is possible to select preferred test cases in accordance with the optimization process. For example, the optimization process makes it possible to reduce the number of man-days indicated by reference character K2 in FIG. 28 to the number of man-days indicated by reference character K3. Thus, for example, the progress estimated as shown in FIG. 24 is changed to the estimated progress as shown in FIG. 29. Such an optimization process and the display of estimated progress are repeatedly performed by simulation, making it possible for the project administrator to readily generate a preferred test plan.

### 2. Second Embodiment

Next, a second embodiment of the present invention will be described. In the first embodiment, the number of man-days required for test execution in the current test project is calculated for each test specification based on the past actual man-day number per test case (see, for example, steps S634 and S636 in FIG. 25). On the other hand, in the present embodiment, the requisite man-day number is calculated in consideration of the worker's (tester's) testing skill, along with the past actual man-day number.

<2.1 Configuration>

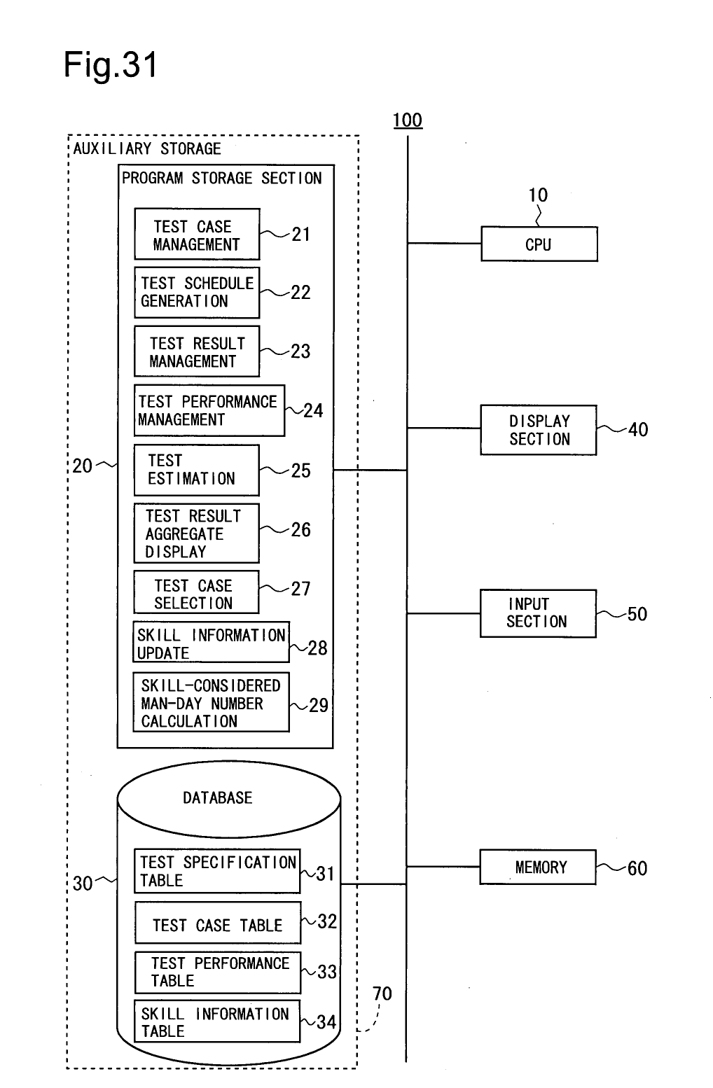

The overall system hardware configuration in the present embodiment is the same as that in the first embodiment shown in FIG. 2. FIG. 31 is a block diagram illustrating the configuration of a test planning assistance apparatus 100 according to the present embodiment. In the present embodiment, in addition to the components in the first embodiment as shown in FIG. 1, the test planning assistance apparatus 100 includes: two programs (execution modules) 28 and 29 provided in the program storage section 20, which are respectively labeled “SKILL INFORMATION UPDATE” and “SKILL-CONSIDERED MAN-DAY NUMBER CALCULATION”; and a table 34 provided in the database 30, which is labeled “SKILL INFORMATION”. Note that the skill-considered man-day number calculation program 29 is a subroutine invoked from the test estimation program 25.

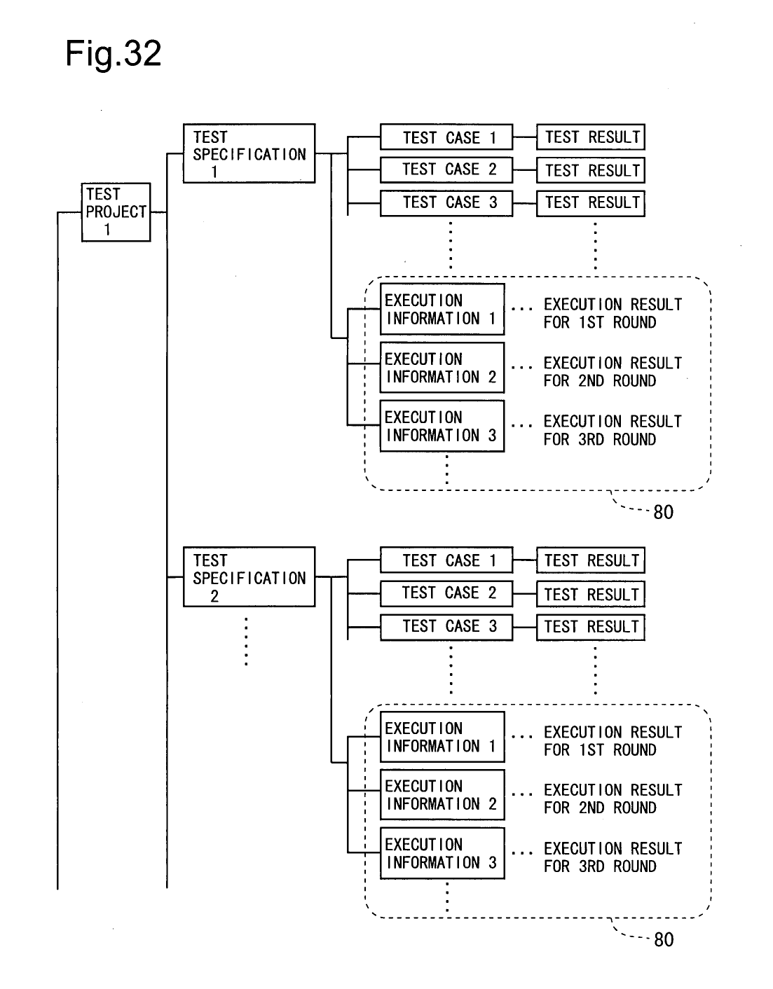

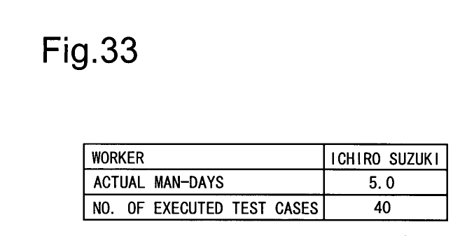

In the present embodiment, each test specification is correlated with execution information 80, which indicates an execution result per test as shown in FIG. 32. For example, information such as “WORKER”, “ACTUAL MAN-DAYS” and “NO. OF EXECUTED TEST CASES” as shown in FIG. 33 is held as the execution information. Note that the test cases may be added to or deleted from each test specification as necessary, and all the test cases are not necessarily executed in each round of testing. Therefore, the “NO. OF EXECUTED TEST CASES” may vary from one round of testing to another even for the same test specification. For example, the number of test cases that are to be executed may be fifty for the first round of testing, and sixty for the second round of testing.

Next, the skill information table 34 will be described. In general, when the same worker repeatedly tests a given test specification, the more tests he/she experiences, the shorter the time (the number of man-days) required for test execution becomes. This is because the worker becomes familiar with operations for the testing. In the present embodiment, the degree of familiarity (skill) is managed by the skill information table 34 as a “coefficient”. Note that the skill information table 34 is provided for each test specification.

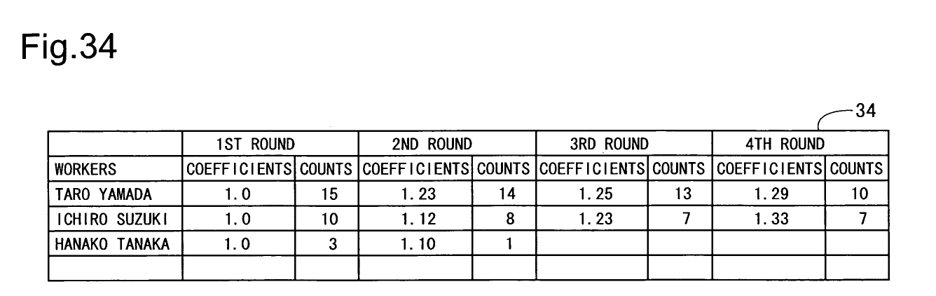

FIG. 34 is a diagram schematically illustrating exemplary data stored in the skill information table 34. For example, looking at data concerning the “3RD ROUND” for “TARO YAMADA” in FIG. 34, '713” in the “COUNTS” field (count information) is meant to indicate that the number of times “TARO YAMADA” has executed three consecutive rounds of testing for an associated test specification is thirteen.

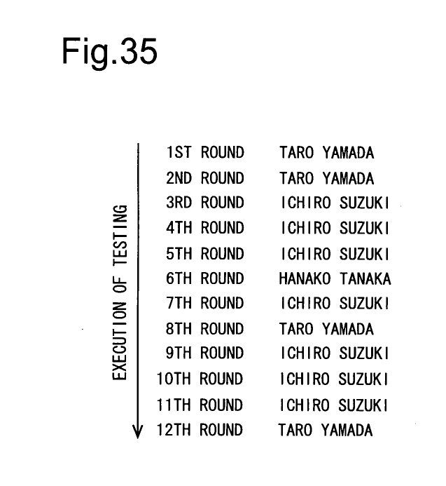

For example, it is assumed that different rounds of testing for a given test specification are executed by workers as shown in FIG. 35. In this example, “TARO YAMADA” is indicated as the worker for both the first and second rounds, which means that “TARO YAMADA” has executed two consecutive rounds of testing. Also, “ICHIRO SUZUKI” is indicated as the worker for the third to fifth rounds, which means that “ICHIRO SUZUKI” has executed three consecutive rounds of testing. Furthermore, “ICHIRO SUZUKI” has also executed three consecutive rounds of testing from the ninth to eleventh rounds. Accordingly, the number of times “ICHIRO SUZUKI” has executed three consecutive rounds of testing is two. In addition, “ICHIRO SUZUKI” is indicated as the worker for the seventh round, while the worker for the sixth round is “HANAKO TANAKA”. In this case, “ICHIRO SUZUKI” in the seventh round has executed only a single round of testing, and has not executed consecutive rounds of testing.

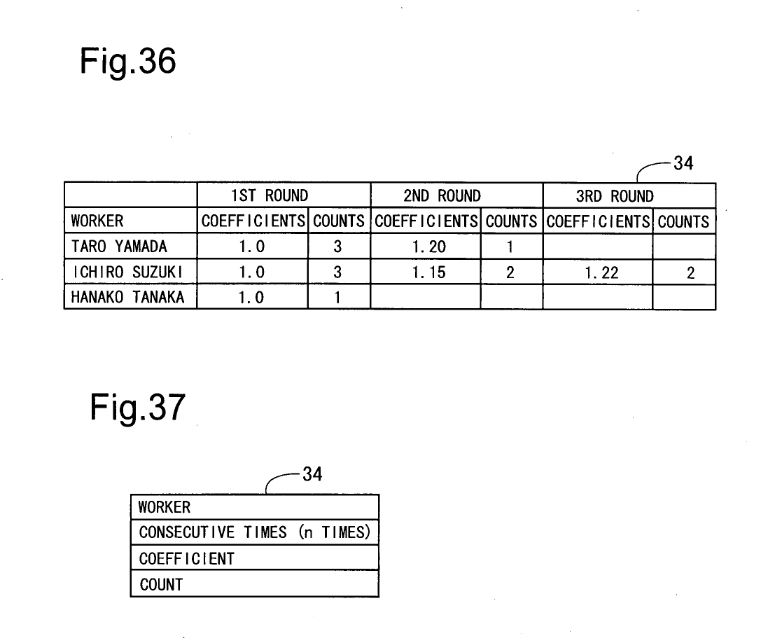

FIG. 36 is a diagram illustrating the contents of the skill information table 34 when the testing is executed in the order of workers as shown in FIG. 35. The following description is given looking at data for “TARO YAMADA”. In this exemplary testing, the number of times “TARO YAMADA” has executed consecutive rounds of testing is “1” at the time points when the first, eighth and twelfth rounds of testing have been executed. Accordingly, in FIG. 36, the “COUNTS” field concerning the “1ST ROUND” for “TARO YAMADA” contains “3”. In addition, “TARO YAMADA” has executed two consecutive rounds of testing only once, i.e., the first to second rounds. Accordingly, in FIG. 36, the “COUNTS” field concerning the “2ND ROUND” for “TARO YAMADA” contains “1”. In this manner, data is stored to the skill information table 34. Note that the procedure for a process for updating the contents of the skill information table 34 (a skill information table updating process) will be described in detail later.

FIG. 37 is a diagram illustrating a record format of the skill information table 34. The skill information table 34 contains a plurality of items, which are respectively labeled “WORKER”, “CONSECUTIVE TIMES”, “COEFFICIENT”, and “COUNT”. Note that in the skill information table 34, a combination of the “WORKER” and the “CONSECUTIVE TIMES” constitutes a primary key. In item fields of the skill information table 34, data items as described below are stored. Stored in the “WORKER” field is the name of the worker called the “tester”. Store in the “CONSECUTIVE TIMES” field is data such as “1ST ROUND”, “2ND ROUND”, . . . , as shown in FIGS. 34 and 36. Stored in the “COEFFICIENT” field is a value indicating the worker's skill for the associated test specification. For example, when “1.2” is stored in the “COEFFICIENT” field, it is meant that the worker can execute the testing 1.2 times as efficiently as the first round of testing, i.e., the worker can execute the testing in 1/1.2 times the number of man-days spent for executing the first round of testing. Stored in the “COUNT” field is the number of times the worker has executed the consecutive rounds of testing. Note that in the present embodiment, a skill information holding section is implemented by the skill information table 34.

<2.2 Skill Information Table Updating Process>

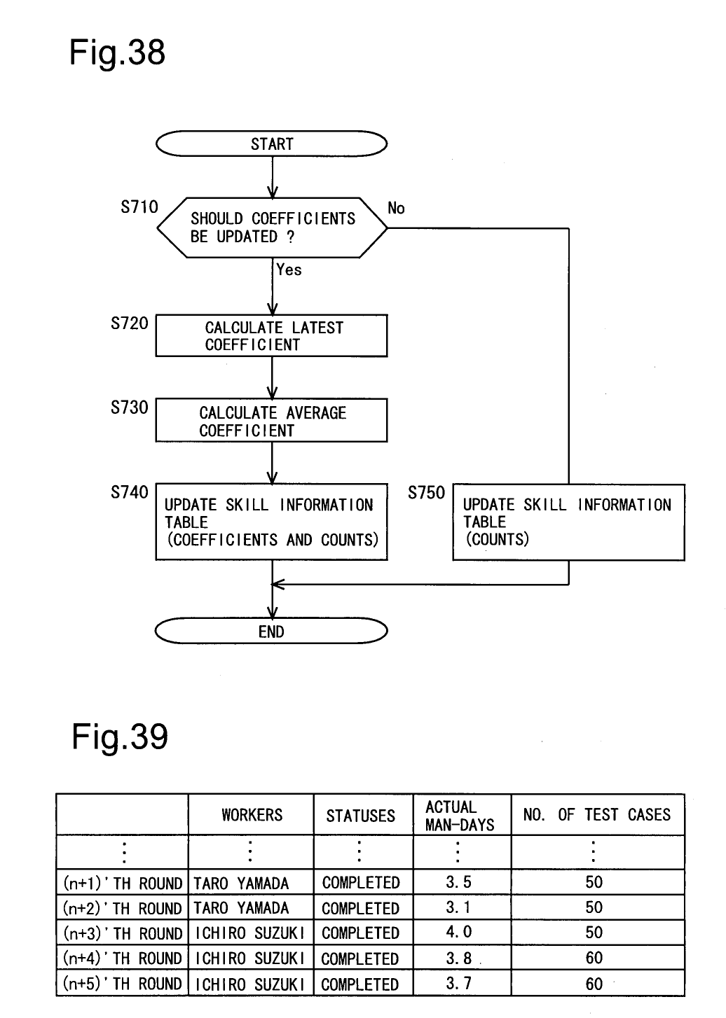

FIG. 38 is a flowchart illustrating the procedure for the skill information table updating process. In the test planning assistance apparatus 100, the skill information table updating process is performed by inputting the actual man-day number for testing to execute the skill information update program 28. The skill information table updating process is described with reference to the following example. Here, it is assumed that testing for a given test specification has been executed as shown in FIG. 39, and the example is given, focusing on the time point when the (n+5) 'th round of testing is completed. Also, at the time point when the (n+4) 'th round of testing is completed, the skill information table 34 is assumed to be as shown in FIG. 34.

When the skill information table updating process is started, the test planning assistance apparatus 100 determines whether to update data for “COEFFICIENTS” in the skill information table 34 (step S710). The determination is made based on whether the same worker has consecutively executed the testing for the test specification a plurality of times. Specifically, if the same worker has consecutively executed the testing a plurality of times, the determination is to update the data for “COEFFICIENTS”, and if not, the determination is to not update the data for “COEFFICIENTS”. If the determination result is that the data for “COEFFICIENTS” is to be updated, the procedure advances to step S720, while if the determination result is that the data for “COEFFICIENTS” is not to be updated, the procedure advances to step S750.

In step S720, the “latest coefficient” is calculated. Here, the “latest coefficient” refers to a value representing the ratio between the actual man-day number per test case for the first one of the consecutive rounds of testing currently being executed and the actual man-day number per test case for the latest round of the testing. In the example shown in FIG. 39, the (n+3) 'th round corresponds to the first one of the consecutive rounds. As for the (n+3) 'th round of testing, the actual man-day number is “4.0”, and the number of executed test cases is “50”. Accordingly, the actual man-day number per test case for the (n+3) 'th round of testing is “0.08”. In addition, in the example shown in FIG. 39, the (n+5) 'th round corresponds to the third one of the consecutive rounds. As for the (n+5) 'th round of testing, the actual man-day number is “3.7”, and the number of executed test cases is “60”. Accordingly, the actual man-day number per test case for the (n+5) 'th round of testing is “0.06”. Here, “0.08” is divided by “0.06” to give “1.33”. Thus, in the example shown in FIG. 39, the “latest coefficient” is “1.33”.

After step S720 is completed, the procedure advances to step S730, where an average coefficient value is calculated. In the example shown in FIG. 39, “ICHIRO SUZUKI” has executed three consecutive rounds of testing at the time point when the (n+5) 'th round of testing is completed. Now, looking at the data concerning the “3RD ROUND” for “ICHIRO SUZUKI” in the skill information table 34 shown in FIG. 34, the coefficient is indicated as “1.23”, which is a past average coefficient value for the seven times “ICHIRO SUZUKI” has executed three consecutive rounds of testing. In step S730, the average coefficient value is recalculated based on the past average coefficient value and the aforementioned latest coefficient. Specifically, the average coefficient value Kave is calculated by the following equation (1):

Kave=(Kold×N+Knew)/(N+1) (1),

where Kold is the past average coefficient value, N is the number of times the consecutive rounds of testing have been executed in the past, and Knew is the latest coefficient.

In the example shown in FIG. 39, Kave=(1.23×7+1.33)/(7+1), hence “1.24”.

After step S730 is completed, the procedure advances to step S740, where the skill information table 34 is updated in terms of the “coefficient” data and the “count” data. In step S740, the “coefficient” data is updated to the average coefficient value Kave calculated in step S730, and the “count” data is updated to a value obtained by adding “1” to the data that has been entered in the “COUNTS” field. In the above example, as for the data concerning the “3RD ROUND” for “ICHIRO SUZUKI” in the skill information table 34 shown in FIG. 34, the “coefficient” data is updated from “1.23” to “1.24”, and the “count” data is updated from “7” to “8”. The skill information table updating process ends upon completion of step S740.

In step S750, the “count” data in the skill information table 34 is updated. Specifically, the data concerning the first round for the corresponding worker is updated to a value obtained by adding “1” to the data that has been entered. The skill information table updating process ends upon completion of step S750. Note that in the present embodiment, a skill information updating section is implemented by steps S710 to S750.

<2.3 Skill-Considered Estimated Man-Day Number Calculation Process>

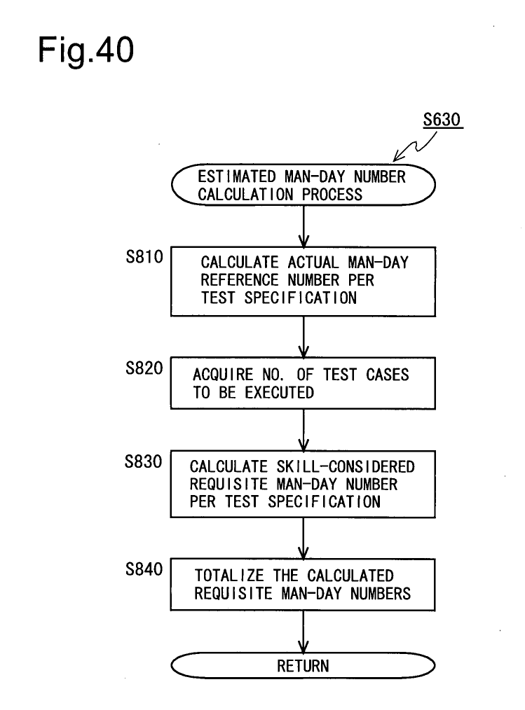

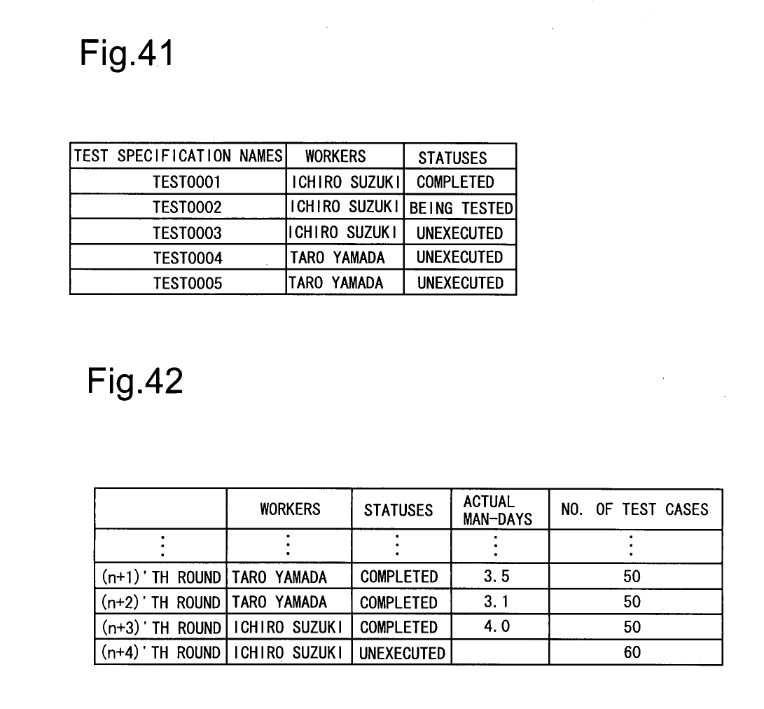

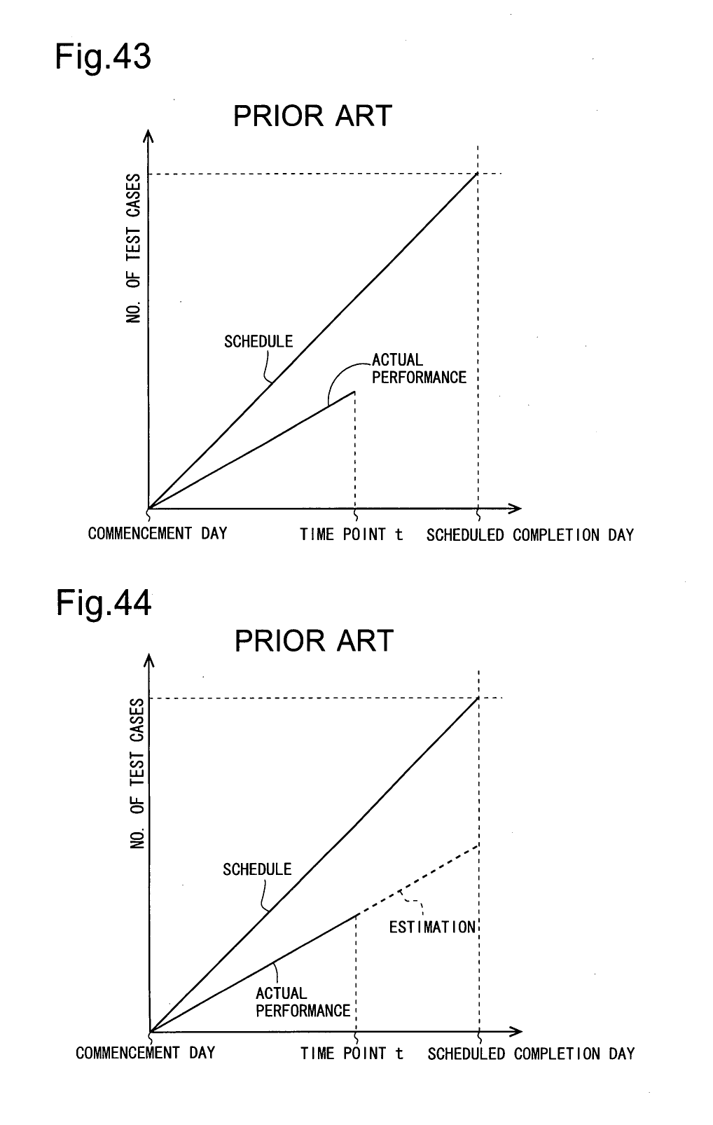

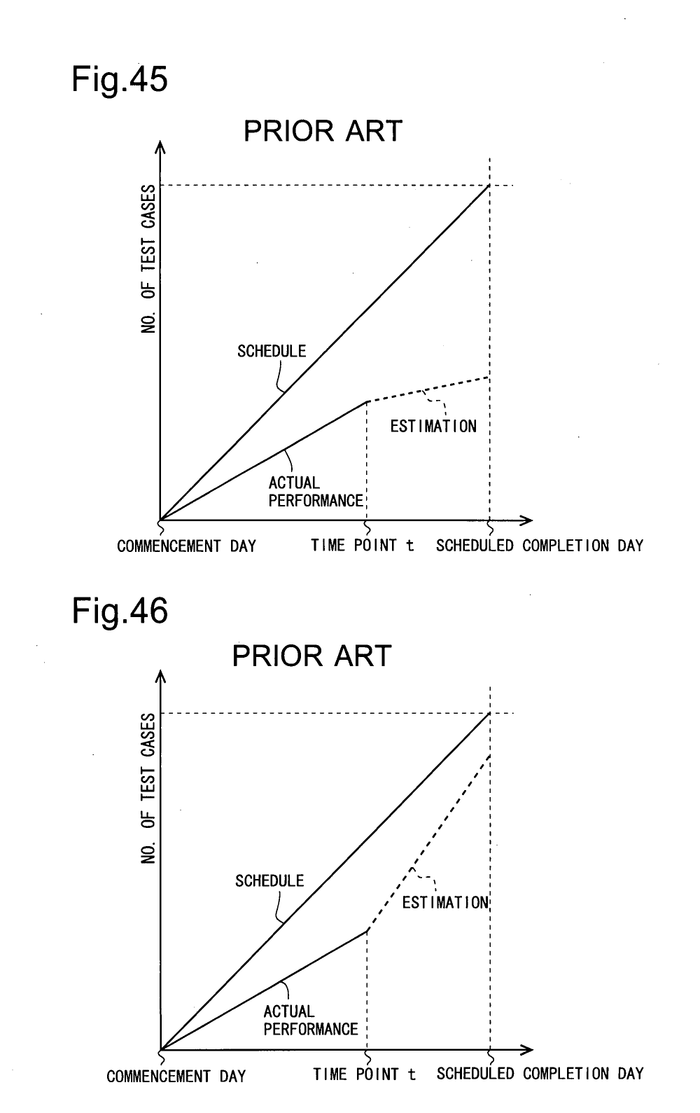

FIG. 40 is a flowchart illustrating the procedure for the estimated man-day number calculation process (step S630 in FIG. 22) in the present embodiment. In the present embodiment, the skill-considered man-day number calculation program 29 is executed to perform the estimated man-day number calculation process. The estimated man-day number calculation process is described with reference to the following example. Here, it is assumed that the test execution status is obtained for each test specification as shown in FIG. 41, and testing for the test specification “TEST0003” from among the test specifications shown in FIG. 41 is executed as shown in FIG. 42.

The estimated man-day number calculation process is performed only on the test specifications whose test operation status is “BEING TESTED” or “UNEXECUTED”. Accordingly, in the example shown in FIG. 41, the specifications “TEST0002”, “TEST0003”, “TEST0004”, and “TEST0005” are processed, but the specification “TEST0001” is not processed.

When the estimated man-day number calculation process is started, the test planning assistance apparatus 100 calculates an actual man-day reference number for each test specification (step S810). Here, the “actual man-day reference number” is meant to indicate the number of man-days that is used as a reference when calculating the estimated man-day number in consideration of skills. Specifically, when the same worker executes consecutive rounds of testing for a given test specification, the actual man-day reference number refers to the number of actual man-days spent per test case in the first one of the consecutive rounds of testing. In the example shown in FIG. 42, “ICHIRO SUZUKI” has consecutively executed the (n+3) 'th to (n+4) 'th rounds of testing. Accordingly, the number of actual man-days spent per test case in the (n+3) 'th round of testing is used as the “actual man-day reference number”. In this case, “4.0” is divided by “50” to give “0.08”. Accordingly, in the example shown in FIG. 42, the “actual man-day reference number” is “0.08”. As such, in step S810, the actual man-day reference number is calculated for each test specification. After step S810 is completed, the procedure advances to step S820.

In step S820, the test planning assistance apparatus 100 acquires the number of test cases that are to be executed for each test specification. In the example shown in FIG. 42, the test planning assistance apparatus 100 acquires “60” as the number of test cases that are to be executed in the (n+4) 'th round. After step S820 is completed, the procedure advances to step S830.

In step S830, the test planning assistance apparatus 100 calculates the requisite man-day number for each test specification in consideration of skills. Specifically, the skill-considered requisite man-day number T is calculated by the following equation (2):

T=(Tbase×X)/K (2),

where Tbase is the actual man-day reference number calculated in step S810, X is the number of test cases acquired in step S820, and K is a coefficient stored in the skill information table 34, regarding the number of consecutive rounds that is to be currently estimated for the corresponding worker.

In the example shown in FIG. 39, T=(0.08×60)/1.12, hence “4.3”.

After step S830 is completed, the procedure advances to step S840. In step S840, the test planning assistance apparatus 100 calculates a sum total of the actual man-day numbers calculated in step S830. As a result, the number of man-days estimated to be required for subsequent test execution in the current test project is calculated. After step S840 is completed, the procedure advances to step S640 in FIG. 22, where the skill-considered estimated man-day number calculation process ends. Note that in the present embodiment, a skill-considered man-day number calculating section is implemented by steps S810 to S840.

<2.4 Effects>

As describe above, according to the present embodiment, the skill information table 34 holds, for each test specification, data indicating each worker's testing skill in relation to the consecutive rounds of testing executed by the worker. Thereafter, the requisite man-day number required for test execution is calculated based on the skill information stored in the skill information table 34. Therefore, the estimated man-day numbers are calculated, considering the individual workers' testing skills. Thus, it is possible to enhance the accuracy of the test plan for each test project, and minimize the difference between the estimated man-day number and the actual man-day number in the test project.

In addition, the contents of the skill information table 34 are updated each time the same worker executes consecutive rounds of testing for a given test specification. Therefore, data concerning each worker's skill is accumulated as the number of testing rounds increases, so that the estimated man-day numbers are more accurately calculated, considering the individual workers' skills.

Furthermore, in the present embodiment, when the same worker is executing consecutive rounds of testing, the number of actual man-days spent per test case in the first one of the consecutive rounds of testing is determined as the actual man-day reference number. Thereafter, the actual man-day reference number is multiplied by the number of test cases that are to be executed in the current round of testing, and the resultant value is divided by a coefficient indicating the skill, thereby calculating the requisite man-day number. Thus, even if the number of test cases that are to be executed varies from one round of testing to another, the estimated man-day numbers can be accurately calculated, considering the individual workers' skills without being affected by variations in the number of test cases.

<3. Others>

The test planning assistance apparatus 100 is implemented by the programs 21 to 27, which are executed by the CPU 10 for the purpose of test case management and so on, on the premise that there are hardware devices such as the memory 60 and the auxiliary storage 70. For example, part or all of the programs 21 to 27 are provided in the form of a computer-readable recording medium such as a CD-ROM, which has the programs 21 to 27 recorded therein. The user can purchase a CD-ROM having the programs 21 to 27 recorded therein, and load the CD-ROM into a CD-ROM drive (not shown), so that the programs 21 to 27 are read from the CD-ROM and installed into the auxiliary storage 70 of the test planning assistance apparatus 100. In this manner, it is possible to provide the programs in order to cause the computer to execute each step shown in the flowcharts.

Also, in each of the above embodiments, the “TEST CASE NO.” in the test specification table 31 is repeated by the number of test cases as shown in FIG. 5. The test specification table 31 may be normalized. Specifically, it is possible to provide the test specification table 31 into two record formats as shown in (A) and (B) of FIG. 30. Similarly, the test case table 32 and the test performance table 33 may be normalized.

Furthermore, each of the above embodiments has been described based on the premise that one test project is executed using a plurality of test specifications, each containing a plurality of test cases, as shown in FIG. 4, but the present invention is not limited to this. The present invention is applicable so long as a plurality of test results can be held for each test case, and the actual man-day number can be held for each round of testing, regarding one or more test cases.

Furthermore, each of the above embodiments has been described with respect to the example where the test planning assistance apparatus 100 is used for testing in the software system development, but the present invention is not limited to this. For example, the present invention is applicable in testing chemical substances, machinery, instruments and equipment, so long as the testing is repeatedly executed.

While the invention has been described in detail, the foregoing description is in all aspects illustrative and not restrictive. It is understood that numerous other modifications and variations can be devised without departing from the scope of the invention.

Note that the present application claims priority to Japanese Patent Application No. 2006-165606, titled “TEST PLANNING ASSISTANCE APPARATUS AND TEST PLANNING ASSISTANCE PROGRAM”, filed on Jun. 15, 2006, and Japanese Patent Application No. 2007-123870, titled “TEST PLANNING ASSISTANCE APPARATUS AND TEST PLANNING ASSISTANCE PROGRAM”, filed on May 8, 2007, which are incorporated herein by reference.

What is claimed is:

1. A test planning assistance apparatus for assisting in generating a test plan for a test project externally designated from among a plurality of repeated test projects, the apparatus comprising:
a test case holding section for holding a plurality of test cases including test cases that are to be executed in the designated test project;
a test result holding section for holding, for each test project, a test result including test execution information that indicates whether each test case has been tested;
an actual man-day number holding section for holding an actual man-day number for each test case group including one or more test cases, wherein the actual man-day number indicates the number of man-days spent for test execution in each test project; and
an estimated man-day number calculating section for calculating an estimated man-day number that indicates the number of man-days estimated to be required for test execution in the designated test project,
wherein the estimated man-day number calculating section calculates the estimated man-day number based on the test execution information held in the test result holding section, regarding the test cases that are to be executed in the designated test project, and the actual man-day number held in the actual man-day number holding section, regarding a test case group including the test cases that are to be executed in the designated test project.

2. The test planning assistance apparatus according to claim 1, further comprising:
an involved worker number input section for externally inputting an involved worker number that indicates the number of workers who execute testing during a term of the designated test project; and
an estimated time period calculating section for calculating a time period estimated to be required for test execution in the designated test project, based on the estimated man-day number calculated by the estimated man-day number calculating section and the involved worker number inputted by the involved worker number input section.

3. The test planning assistance apparatus according to claim 2, further comprising an estimated test progress display section for displaying a numerical value or a graph with respect to estimated progress of testing during the term of the designated test project, based on the estimated time period calculated by the estimated time period calculating section.

4. The test planning assistance apparatus according to claim 1, wherein the estimated man-day number calculating section includes:
a first arithmetic section for calculating a group-specific actual man-day average number for each test case group, based on the test execution information held in the test result holding section and the actual man-day number held in the actual man-day number holding section, wherein the group-specific actual man-day average number indicates the number of actual man-days per test case; and
a second arithmetic section for calculating the estimated man-day number based on the group-specific actual man-day average number calculated by the first arithmetic section and the number of test cases that are to be executed per test case group in the designated test project.

5. The test planning assistance apparatus according to claim 4,
wherein the first arithmetic section includes:
a project-specific actual man-day average number calculating section for calculating a project-specific actual man-day average number for each test case group in each test project, based on the test execution information held in the test result holding section and the actual man-day number held in the actual man-day number holding section, wherein the project-specific actual man-day average number indicates the number of actual man-days per test case in the test project; and
a group-specific actual man-day average number calculating section for calculating a sum total of the project-specific actual man-day average numbers calculated by the project-specific actual man-day average number calculating section, and dividing the sum total of the project-specific actual man-day average numbers by the number of test projects that have already been executed, thereby calculating the group-specific actual man-day average number, and
wherein the second arithmetic section includes:
a group-specific requisite man-day number calculating section for calculating a requisite man-day number for each test case group by multiplying the number of test cases that are to be executed in the designated test project by the group-specific actual man-day average number for the test case group, wherein the requisite man-day number indicates the number of man-days required for test execution in the designated test project; and
a group-specific requisite man-day number totalizing section for calculating the estimated man-day number by obtaining a sum total of the requisite man-day numbers calculated by the group-specific requisite man-day number calculating section.

6. The test planning assistance apparatus according to claim 1, further comprising:
a skill information holding section for holding skill information that indicates each worker's testing skill for each test case group; and
a skill information updating section for updating the skill information in the skill information holding section when the same worker has executed consecutive rounds of testing for the same test case group, wherein when the number of consecutive rounds is P, which is a natural number of two or higher, the skill information regarding the P'th round of testing is updated based on the number of actual man-days spent for executing the first one of the P consecutive rounds of testing and the number of actual man-days spent for executing the P'th round of testing,
wherein the estimated man-day number calculating section includes a skill-considered man-day number calculating section for calculating a requisite man-day number when the same worker is executing consecutive rounds of testing for the same test case group, wherein when the number of consecutive rounds is Q, which is a natural number of two or higher, the requisite man-day number indicates the number of man-days required for executing the Q'th round of testing, and is calculated based on the skill information held in the skill information holding section, regarding the Q'th round of testing.

7. The test planning assistance apparatus according to claim 6,
wherein the skill information holding section further holds count information that indicates the number of times the same worker has executed consecutive rounds of testing for the same test case group, wherein when the number of consecutive rounds is up to R, which is a natural number of two or higher, the count information indicates the number of times the consecutive rounds of testing has been executed, for each number of consecutive rounds from two to R, and
wherein the skill information updating section calculates the worker's testing skill regarding the P'th round of testing by the following equation:
Kave=(Kold×N+Knew)/(N+1),
where Kave is the testing skill for the P'th round of testing, Kold is the testing skill for the P'th round of testing before the skill information is updated by the skill information updating section, N is the number of times the P consecutive rounds of testing have been executed before the skill information is updated by the skill information updating section, the number of times being held in the skill information holding section as the count information before the skill information is updated by the skill information updating section, and Knew is a skill calculated according to a ratio between the number of actual man-days per test case for executing the first one of the P consecutive rounds of testing and the number of actual man-days per test case for executing the P'th round of testing.

8. The test planning assistance apparatus according to claim 6, wherein when the same worker is executing the Q consecutive rounds of testing for the same test case group, the skill-considered man-day number calculating section calculates the requisite man-day number indicating the number of man-days required for executing the Q'th round of testing in accordance with the following equation, based on the actual man-day reference number calculated by dividing the number of actual man-days spent for executing the first one of the Q consecutive rounds of testing by the number of test cases executed in the first round of testing:
T=(Tbase×X)/K,
where T is the number of man-days required for executing the Q'th round of testing, Tbase is the actual man-day reference number, X is the number of test cases that are to be executed in the Q'th round of testing, and K is the skill information held in the skill information holding section, regarding the Q'th round of testing.

9. The test planning assistance apparatus according to claim 1, further comprising:
a scheduled test case number calculating section for calculating a scheduled test case number based on the number of test cases that are to be executed in the designated test project and a given number of days that indicates a term of the designated test project, wherein the scheduled test case number indicates the number of test cases that are to be tested per day during the term of the designated test project; and
a test progress schedule display section for displaying a numerical value or a graph indicating a test progress schedule during the term of the designated test project based on the scheduled test case number calculated by the scheduled test case number calculating section.

10. The test planning assistance apparatus according to claim 1, further comprising:
an executed test case number acquiring section for acquiring an executed test case number based on the test execution information held in the test result holding section, regarding the designated test project, wherein the executed test case number indicates the number of test cases that have already been tested in the designated test project; and
an actual test progress display section for displaying a numerical value or a graph that indicates actual test progress during the term of the designated test project, based on the executed test case number acquired by the executed test case number acquiring section.

11. The test planning assistance apparatus according to claim 1, further comprising a test result aggregate display section for displaying a numerical value or a graph that indicates a test result aggregate for test projects that have already been executed, based on the test results held in the test result holding section.

12. The test planning assistance apparatus according to claim 1, further comprising a test case selecting section for selecting the test cases that are to be executed in the designated test project, based on the test results held in the test result holding section.

13. A computer-readable recording medium having recorded therein a test planning assistance program for use with a test planning assistance apparatus for assisting in generating a test plan for a test project externally designated from among a plurality of repeated test projects, the program causing the apparatus to execute:
a test case holding step for holding, in a predetermined test case holding section, a plurality of test cases including test cases that are to be executed in the designated test project;
a test result holding step for holding a test result for each test project in a predetermined test result holding section, wherein the test result includes test execution information that indicates whether each test case has been tested;
an actual man-day number holding step for holding, in a predetermined actual man-day number holding section, an actual man-day number for each test case group including one or more test cases, wherein the actual man-day number indicates the number of man-days spent for test execution in each test project; and
an estimated man-day number calculating step for calculating an estimated man-day number that indicates the number of man-days estimated to be required for test execution in the designated test project,
wherein in the estimated man-day number calculating step, the estimated man-day number is calculated based on the test execution information held in the test result holding section, regarding the test cases that are to be executed in the designated test project, and the actual man-day number held in the actual man-day number holding section, regarding a test case group including the test cases that are to be executed in the designated test project.

14. The computer-readable recording medium according to claim 13, wherein the test planning assistance program further causing the test planning assistance apparatus to execute:
an involved worker number input step for externally inputting an involved worker number that indicates the number of workers who execute testing during a term of the designated test project; and
an estimated time period calculating step for calculating a time period estimated to be required for test execution in the designated test project, based on the estimated man-day number calculated in the estimated man-day number calculating step and the involved worker number inputted in the involved worker number input step.

15. The computer-readable recording medium according to claim 14, wherein the test planning assistance program further causing the test planning assistance apparatus to execute:
an estimated test progress display step for displaying a numerical value or a graph with respect to estimated progress of testing during the term of the designated test project, based on the estimated time period calculated in the estimated time period calculating step.

16. The computer-readable recording medium according to claim 13, wherein the estimated man-day number calculating step includes:
a first arithmetic step for calculating a group-specific actual man-day average number for each test case group, based on the test execution information held in the test result holding section and the actual man-day number held in the actual man-day number holding section, wherein the group-specific actual man-day average number indicates the number of actual man-days per test case; and
a second arithmetic step for calculating the estimated man-day number based on the group-specific actual man-day average number calculated in the first arithmetic step and the number of test cases that are to be executed per test case group in the designated test project.

17. The computer-readable recording medium according to claim 16,
wherein the first arithmetic step includes:
a project-specific actual man-day average number calculating step for calculating a project-specific actual man-day average number for each test case group in each test project, based on the test execution information held in the test result holding section and the actual man-day number held in the actual man-day number holding section, wherein the project-specific actual man-day average number indicates the number of actual man-days per test case in the test project; and
a group-specific actual man-day average number calculating step for calculating a sum total of the project-specific actual man-day average numbers calculated in the project-specific actual man-day average number calculating step, and dividing the sum total of the project-specific actual man-day average numbers by the number of test projects that have already been executed, thereby calculating the group-specific actual man-day average number, and
wherein the second arithmetic step includes:
a group-specific requisite man-day number calculating step for calculating a requisite man-day number for each test case group by multiplying the number of test cases that are to be executed in the designated test project by the group-specific actual man-day average number for the test case group, wherein the requisite man-day number indicates the number of man-days required for test execution in the designated test project; and
a group-specific requisite man-day number totalizing step for calculating the estimated man-day number by obtaining a sum total of the requisite man-day numbers calculated in the group-specific requisite man-day number calculating step.

18. The computer-readable recording medium according to claim 13,
wherein the test planning assistance program further causing the test planning assistance apparatus to execute:
a skill information holding step for holding, in a predetermined skill information holding section, skill information that indicates each worker's testing skill for each test case group; and
a skill information updating step for updating the skill information in the skill information holding section when the same worker has executed consecutive rounds of testing for the same test case group, wherein when the number of consecutive rounds is P, which is a natural number of two or higher, the skill information regarding the P'th round of testing is updated based on the number of actual man-days spent for executing the first one of the P consecutive rounds of testing and the number of actual man-days spent for executing the P'th round of testing,
wherein the estimated man-day number calculating step includes a skill-considered man-day number calculating step for calculating a requisite man-day number when the same worker is executing consecutive rounds of testing for the same test case group, wherein when the number of consecutive rounds is Q, which is a natural number of two or higher, the requisite man-day number indicates the number of man-days required for executing the Q'th round of testing, and is calculated based on the skill information held in the skill information holding section, regarding the Q'th round of testing.

19. The computer-readable recording medium according to claim 18,
wherein in the skill information holding step, the skill information holding section further holds count information that indicates the number of times the same worker has executed consecutive rounds of testing for the same test case group, wherein when the number of consecutive rounds is up to R, which is a natural number of two or higher, the count information indicates the number of times the consecutive rounds of testing has been executed, for each number of consecutive rounds from two to R, and
wherein in the skill information updating step, the worker's testing skill regarding the P'th round of testing is calculated by the following equation:
Kave=(Kold×N+Knew)/(N+1),
where Kave is the testing skill for the P'th round of testing, Kold is the testing skill for the P'th round of testing before the skill information is updated in the skill information updating step, N is the number of times the P consecutive rounds of testing have been executed before the skill information is updated in the skill information updating step, the number of times being held in the skill information holding section as the count information before the skill information is updated in the skill information updating step, and Knew is a skill calculated according to a ratio between the number of actual man-days per test case for executing the first one of the P consecutive rounds of testing and the number of actual man-days per test case for executing the P'th round of testing.

20. The computer-readable recording medium according to claim 18, wherein in the skill-considered man-day number calculating step, when the same worker is executing the Q consecutive rounds of testing for the same test case group, the requisite man-day number indicating the number of man-days required for executing the Q'th round of testing is calculated in accordance with the following equation, based on the actual man-day reference number calculated by dividing the number of actual man-days spent for executing the first one of the Q consecutive rounds of testing by the number of test cases executed in the first round of testing:
T=(Tbase×X)/K,
where T is the number of man-days required for executing the Q'th round of testing, Tbase is the actual man-day reference number, X is the number of test cases that are to be executed in the Q'th round of testing, and K is the skill information held in the skill information holding section, regarding the Q'th round of testing.

21. The computer-readable recording medium according to claim 13, wherein the test planning assistance program further causing the test planning assistance apparatus to execute:
a scheduled test case number calculating step for calculating a scheduled test case number based on the number of test cases that are to be executed in the designated test project and a given number of days that indicates a term of the designated test project, wherein the scheduled test case number indicates the number of test cases that are to be tested per day during the term of the designated test project; and
a test progress schedule display step for displaying a numerical value or a graph indicating a test progress schedule during the term of the designated test project based on the scheduled test case number calculated in the scheduled test case number calculating step.

22. The computer-readable recording medium according to claim 13, wherein the test planning assistance program further causing the test planning assistance apparatus to execute:
an executed test case number acquiring step for acquiring an executed test case number based on the test execution information held in the test result holding section, regarding the designated test project, wherein the executed test case number indicates the number of test cases that have already been tested in the designated test project; and
an actual test progress display step for displaying a numerical value or a graph that indicates actual test progress during the term of the designated test project, based on the executed test case number acquired in the executed test case number acquiring step.

23. The computer-readable recording medium according to claim 13, wherein the test planning assistance program further causing the test planning assistance apparatus to execute:
a test result aggregate display step for displaying a numerical value or a graph that indicates a test result aggregate for test projects that have already been executed, based on the test results held in the test result holding section.

24. The computer-readable recording medium according to claim 13, wherein the test planning assistance program further causing the test planning assistance apparatus to execute:
a test case selecting step for selecting the test cases that are to be executed in the designated test project, based on the test results held in the test result holding section.

25. A test planning assistance method for assisting in generating a test plan for a test project externally designated from among a plurality of repeated test projects, the method comprising:
a test case holding step for holding, in a predetermined test case holding section, a plurality of test cases including test cases that are to be executed in the designated test project;
a test result holding step for holding a test result for each test project in a predetermined test result holding section, wherein the test result includes test execution information that indicates whether each test case has been tested;
an actual man-day number holding step for holding, in a predetermined actual man-day number holding section, an actual man-day number for each test case group including one or more test cases, wherein the actual man-day number indicates the number of man-days spent for test execution in each test project; and
an estimated man-day number calculating step for calculating an estimated man-day number that indicates the number of man-days estimated to be required for test execution in the designated test project,
wherein in the estimated man-day number calculating step, the estimated man-day number is calculated based on the test execution information held in the test result holding section, regarding the test cases that are to be executed in the designated test project, and the actual man-day number held in the actual man-day number holding section, regarding a test case group including the test cases that are to be executed in the designated test project.
